(19) United States
(12) Patent Application Publication
(10) Pub. No.: US 2025/0053499 A1
(43) Pub. Date: Feb. 13, 2025

(54) APPLICATION FUNCTIONALITY TESTING, RESILIENCY TESTING, CHAOS TESTING, AND PERFORMANCE TESTING USING MACHINE LEARNING

(71) Applicant: CITI CANADA TECHNOLOGY SERVICES ULC, Toronto (CA)

(72) Inventors: Ramkumar Ayyadurai, Princeton Junction, NJ (US); Vishal Row Mysore, Concord (CA); Chitrabhanu Das, Pune (IN); Sumit Sood, Pune (IN)

(21) Appl. No.: 18/387,348

(22) Filed: Nov. 6, 2023

Related U.S. Application Data
(63) Continuation-in-part of application No. 17/961,106, filed on Oct. 6, 2022, now Pat. No. 11,847,046.

(51) Int. Cl. G06F 11/36

(52) U.S. Cl. CPC G06F 11/3684; G06F 11/3664; G06F 11/3688

(57) ABSTRACT

A network system to use machine learning systems to create chaos testing scenarios on cloud-based applications. The system uses inputs from applications that are implemented on user computing devices to allow users to interface with a network or other system. The system creates a model of the application based on input data received from a network of applications, the model representing a structure, method, and dependencies of the application. The system identifies points of failure of the application and generates one or more chaos testing simulation scenarios that target the identified points of failure. The system performs the chaos testing based on the received simulation scenarios and logs the results of the testing. The system generates recommendations to revise code of the application based on the outcome of the chaos testing. A large language model may be used to provide documentation and analysis of the chaos testing.

### CROSS REFERENCE TO RELATED APPLICATIONS

This application claims priority to and is a continuation-in-part of co-pending U.S. patent application Ser. No. 17/961,106 filed Oct. 6, 2022, entitled “Application Functionality Testing, Resiliency Testing, Chaos Testing, and Performance Testing in a Single Platform”, the entire contents of which are hereby expressly incorporated herein by this reference including, without limitation, the specification, claims, and abstract, as well as any figures, tables, or drawings thereof

### FIELD OF THE INVENTION

The technology relates generally to the field of cloud-based application testing, and more particularly to methods and systems to use machine learning to provide a single holistic integrated platform that incorporates machine learning systems for functionality testing, resiliency testing, chaos testing, and performance testing in the application's cloud infrastructure in plain English/Behavior Driven Development (“BDD”) format, individually or in combination, along with integration capabilities to generate application code coverage against the above tests performed, real time results monitoring and live feeds to external monitoring systems.

### BACKGROUND OF THE INVENTION

Businesses and other systems conventionally provide access to programs, applications, software, and other services to users, such as customers, merchants, operators, business partners, and other computing systems or people. Many of the applications to provide services to users are operated on a cloud computing system. The businesses may provide applications to conduct transactions, conduct social interactions, log events, access accounts, or perform any other types of interactions.

The cloud computing system may utilize containers stored on the cloud system to implement microservices of the application or perform other tasks. The containers, when operating together, allow a user to access the cloud computing system and operate the application as intended. For example, one container may host a microservice to allow a user to login to an application. Another container may host a microservice to allow a user to conduct an interaction with a database that stores the user's account. Another container may host a microservice to download data from the database. Any other types of microservices or other application design patterns may be provided by the cloud-based system to manage the application operations. Cloud applications with varied and different application architectures demand a unified and holistic testing platform which is architecture agnostic.

Cloud-based systems that utilize many containers or other types of nodes may be difficult to test because interactions between the multiple containers are difficult to predict. Performing tests that cause interruptions in the containers of active applications may create cascading failures that cause the entire system to collapse.

Business management applications and other related applications are becoming increasingly complex. These applications have a diverse technology stack, an extensive set of functionalities, and several overlapping features with regards to regulatory, compliance and audit requirements. Large businesses require that these applications are not only functionally validated but also are sufficiently resilient to recover from any hardware, infrastructure, or capacity issues. Deploying the applications on cloud systems adds another level of complexity as any cloud deployment tends to add multiple points of failure. Complex applications also tend to have complex testing requirements. Conventional testing services are unable to fully test and validate complex applications that utilize multiple microservices deployed on a cloud system. Conventional testing services are unable to provide functionality testing, resiliency testing, chaos testing and performance testing in a single tool and neither the current tools have the capability to perform various combination of tests in a mix and match, scheduled or on demand style.

### BRIEF DESCRIPTION OF THE DRAWINGS

FIG. 1 is a block diagram depicting a system to perform cloud-based application testing.

FIG. 2 is a block flow diagram depicting a method to perform cloud-based application testing.

FIG. 3 is a block flow diagram of a method to receive chaos testing inputs from user interface and perform resiliency testing/chaos experiments.

FIG. 4 is an illustration of an example testing graphical user interface.

FIG. 5 is an illustration of code to devise a chaos scenario.

FIGS. 6a and 6b is an illustration of code to devise a chaos scenario.

FIG. 7 depicts a computing machine and a module to provide mutable access tokens.

### DETAILED DESCRIPTION

### Example System Architecture

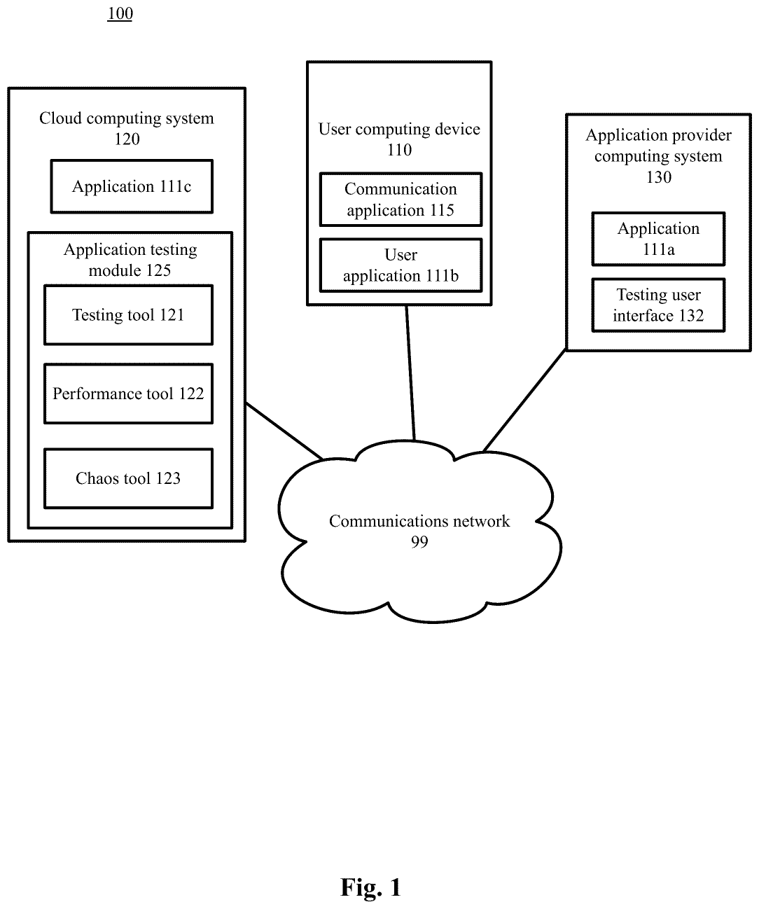

FIG. 1 is a block diagram depicting a system to perform cloud-based application testing. As depicted in FIG. 1, the architecture 100 includes a user computing device 110, cloud computing system 120, and an application provider computing system 130 connected by communications network 99.

Each network, such as communication network 99, includes a wired or wireless telecommunication mechanism and/or protocol by which the components depicted in FIG. 1 can exchange data. For example, each network 99 can include a local area network (“LAN”), a wide area network (“WAN”), an intranet, an Internet, a mobile telephone network, storage area network (SAN), personal area network (PAN), a metropolitan area network (MAN), a wireless local area network (WLAN), a virtual private network (VPN), a cellular or other mobile communication network, Bluetooth, NFC, Wi-Fi, or any combination thereof or any other appropriate architecture or system that facilitates the communication of signals or data. Throughout the discussion of example embodiments, the terms “data” and “information” are used interchangeably herein to refer to text, images, audio, video, or any other form of information that can exist in a computer-based environment. The communication technology utilized by the components depicted in FIG. 1 may be similar to network technology used by network 99 or an alternative communication technology.

Each component depicted in FIG. 1 includes a computing device having a communication application capable of transmitting and receiving data over the network 99 or a similar network. For example, each can include a server, desktop computer, laptop computer, tablet computer, a television with one or more processors embedded therein and/or coupled thereto, smart phone, handheld or wearable computer, personal digital assistant (“PDA”), other wearable device such as a smart watch or glasses, wireless system access point, or any other processor-driven device.

In the example embodiment depicted in FIG. 1, the user computing device 110 is operated by an end-user that may communicate with a cloud computing system 120 to access services related to one or more applications that are operating on the cloud computing device 120. The cloud computing system 120 may be operated by a networking business, a third-party platform, an organization that provides cloud computing services to users, or any type of cloud computing system. The application provider operating the application provider computing system 130 may be a service provider that provides application services, transaction services, database services, or any other type of service that utilizes applications and data. While each server, system, and device shown in the architecture is represented by one instance of the server, system, or device, multiple instances of each can be used.

As shown in FIG. 1, the user computing device 110 includes a data storage unit (not shown) accessible by a communication application 115. The communication application 115 on the user computing device 110 may be, for example, a web browser application or a stand-alone application, to view, download, upload, or otherwise access documents, user interfaces, or web pages via the networks 99. The communication application 115 can interact with web servers or other computing devices connected to the network 99, such as by conducting and authorizing an interaction with the cloud computing system 120 and an application provider computing system 130.

In the examples, the application 111 is developed on the application provider computing system 130, accessed by a downloaded version on the user computing device 110, and operated by on the cloud computing system 120. The application 111 may be stored and operated by the three devices for each of these purposes. The application 111 is represented on the three devices as application 111a, 111b, and 111c.

An instance of the user application 111b that is utilized by the user is located on the user computing device 110. An instance of the user application 111a may be located on the application provider computing system 130, such as when configuring, developing, or monitoring the application 111. An instance of the user application 111c may be located on the cloud computing system 120, such as when configuring, deploying, operating, or managing the application 111 with one or more containers or microservices. The application 111 may represent a single microservice or a group of microservices acting jointly to provide services to the user via the application 111. Microservice architectures use an architectural style that structures an application as a collection of services that are: independently deployable and loosely coupled. With monolithic architectures, the processes are tightly coupled and run as a single service. If one process of the application experiences a spike in demand, the entire architecture must be scaled. Adding or improving a monolithic application's features becomes more complex as the code base grows. This complexity limits experimentation and makes it difficult to implement new ideas.

With a microservices architecture, an application is built with independent components that run each application process as a service. These services communicate via a well-defined interface using lightweight APIs. Each service may perform only a single function. Because the microservices are independently operated, each service can be updated, deployed, and scaled to meet demand for specific functions of an application.

The user computing device 110 includes the user application 111b. The user application 111b may be any type of software, hardware, application, program, webpage, or other type of application that is used by the user computing device 110 to provide a service via the application provider computing system 130. For example, the user application 111b may be an application that manages an account of a user with a system associated with the application provider computing system 130. The user application 111b may be provided by the application provider computing system 130 or the cloud computing system 120, such as by allowing the user computing device 110 to download the application 111b. The application provider computing system 130 may provide services to allow the user application 111b to access software or data from the cloud computing system 120. In another example, the user application 111b is not utilized by a human user of the user computing device 110 but is a background application that allows B2B interactions between the cloud computing system 120 and the user computing device 110 or others.

As shown in FIG. 1, the application provider computing system 130 includes a data storage unit (not shown) accessible by a testing user interface 132. The application provider computing system 130 may interact with web servers or other computing devices connected to the network 99, such as by managing interactions with the user computing device 110 and the cloud computing system 120. In certain examples, the application provider computing system 130 develops an application 111a to allow users to interact with a business, institution, or other entity. The application provider computing system 130 may be a function of the entity or third party that is contracted to develop the application 111a. The application 111a may allow a user to interact with the application provider computing system 130 or an entity associated with the application provider computing system 130.

As shown in FIG. 1, the cloud computing system 120 includes a testing tool 121, a performance tool 122, and a chaos tool 123 that are operating on an application testing module 125, and an application 111c. Each of these functions or devices may be encoded in hardware or software, may be functions of a device of the cloud computing system 120 such as a server, may be separate devices connected to other devices of the cloud computing system 120, or may be functions or algorithms operating on other devices of the cloud computing system 120. The cloud computing system 120 may represent a network of remote servers hosted on a network to store, manage, and process data, rather than a local server or a personal computer. The application testing module 125 may represent a tool, program, algorithm, or other function of the cloud computing system 120 that hosts and operates the tools 121, 122, 123.

The testing tool 121 represents a function, software, hardware, algorithm, or other type of process to perform testing on an application or microservice, such as the microservices provided by application 111c. For example, the testing tool 121 may verify that a microservice in a container on a cloud pod is operational, has sufficient processing capacity, interacts with other required microservices, and perform other functional tests as described herein. The performance tool 122 represents a function, software, hardware, algorithm, or other type of process to test the capacity and stability of an application or microservice as described herein. For example, the performance tool 122 may perform loading tests to determine the capacity that the microservice may tolerate before failure. The chaos tool 123 represents a function, software, hardware, algorithm, or other type of process to perform chaos testing on an application or microservice. For example, the chaos tool 123 may inject random or systematic errors and failures into the system to monitor the results as described herein. The tools 121, 122, 123 of the cloud computing system may operate or be managed as a single tool that performs the three functions on the cloud computing system 120.

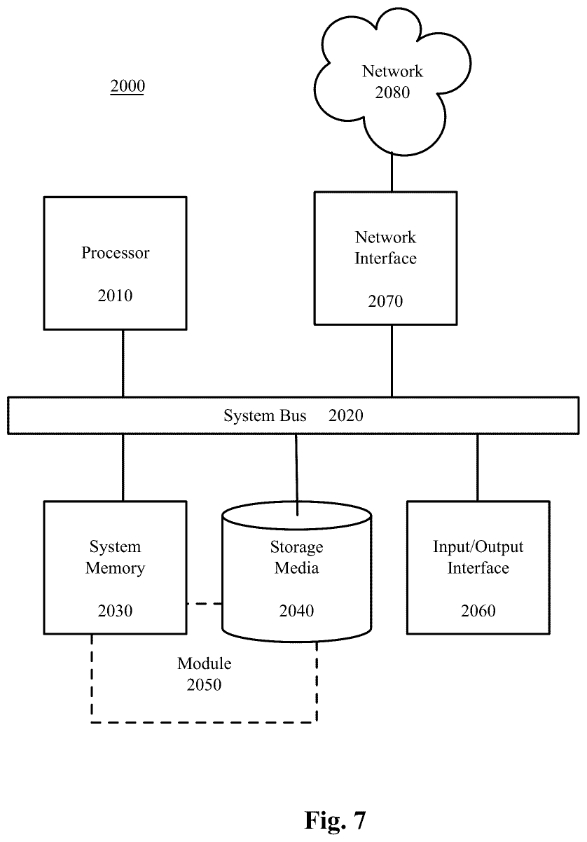

In example embodiments, the network computing devices and any other computing machines associated with the technology presented herein may be any type of computing machine such as, but not limited to, those discussed in more detail with respect to FIG. 7. Furthermore, any functions, applications, or components associated with any of these computing machines, such as those described herein or any others (for example, scripts, web content, software, firmware, hardware, or modules) associated with the technology presented herein may by any of the components discussed in more detail with respect to FIG. 7. The computing machines discussed herein may communicate with one another, as well as with other computing machines or communication systems over one or more networks, such as network 99. The network 99 may include any type of data or communications network, including any of the network technology discussed with respect to FIG. 7.

### Example Embodiments

Reference will now be made in detail to embodiments of the invention, one or more examples of which are illustrated in the accompanying drawings. Each example is provided by way of explanation of the invention, not as a limitation of the invention. Those skilled in the art will recognize that various modifications and variations can be made in the present invention without departing from the scope or spirit of the invention. For example, features illustrated or described as part of one embodiment can be used in another embodiment to yield a still further embodiment. Thus, the technology covers such modifications and variations that come within the scope of the invention.

The technology for embodiments of the invention may employ methods and systems to provide functionality testing, resiliency testing, chaos testing, and performance testing in a single tool that operates on cloud-based applications in real time. When applications are deployed on a cloud environment, the applications must be validated based on functional aspects, performance aspects, resiliency aspects, and test-code coverage ratio aspects. The system herein combines all these validations in a single package. The system provides a rich set of modules for functional validations, which can be combined as nodes in the system to allow applications to be quickly validated for functionality. The extensible model of the same functional modules may also be used for performance testing of the application. The system also provides resiliency and chaos testing mechanisms that push the applications into a constant state of perturbation. The system does so by detecting the application code and modifying the code at runtime to inject perturbation. In an example, the system operates as a Kubernetes operator. This operation environment would allow the application to be validated seamlessly because the operations could be performed in transparent way without adding delay to the time required to release the application.

The examples for embodiments of the invention may employ computer hardware and software, including, without limitation, one or more processors coupled to memory and non-transitory computer-readable storage media with one or more executable computer application programs stored thereon, which instruct the processors to perform such methods.

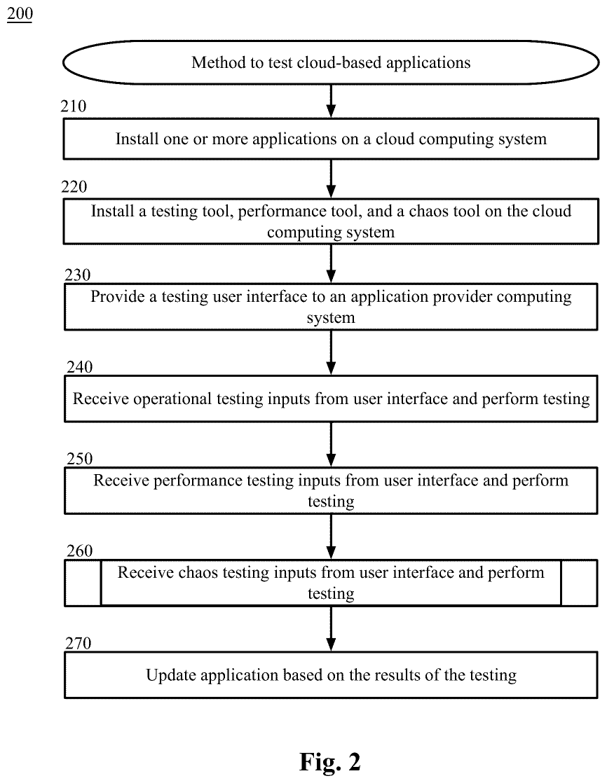

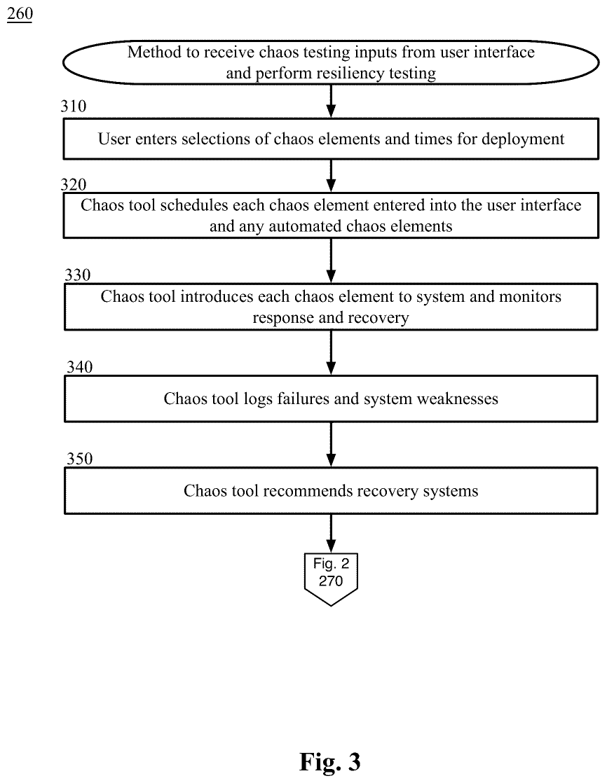

The example methods illustrated in FIGS. 2-3 are described hereinafter with respect to the components of the example communications and processing architecture 100.

FIG. 2 is a block flow diagram depicting a method 200 to test cloud-based applications.

In block 210, one or more applications 111c are installed on a cloud computing system 120. In the examples, an instance of the user application 111b that is utilized by the user is located on the user computing device 110. An instance of the user application 111a may be located on the application provider computing system 130, such as when configuring, developing, or monitoring the application 111. An instance of the user application 111c may be located on the cloud computing system 130, such as when configuring, deploying, operating, or managing the application 111 with one or more containers or microservices. The application 111c may represent a single microservice or a group of microservices acting jointly to provide services to the user via the application 111.

In the example, microservices of the application 111c are uploaded into containers on the cloud computing system 120, such as a Kubernetes system. The application 111a may be developed by the application provider computing system 130 and communicated to the cloud computing system 120 for deployment. The cloud computing system 120 is configured to provide communications with user computing devices 110 that request access to services or data via applications 111b operating on the user computing device. The application provider computing system 130 or the cloud computing system 120 may determine the number and type of containers that are used to operate and manage the microservices of the application 111c.

The microservices may be any functions that, when used in conjunction with other microservices, combine to allow a user to operate an application 111b on a user computing device 110 to obtain services or data from a business or institution. For example, the application 111b may allow a user to conduct transactions with a banking institution. For example, one microservice may allow a user to sign in. Another microservice may allow a user to access a user account history. Another microservice may allow a user to conduct a transaction. Another microservice may allow the banking institution to monitor activities of the user on the application 111b. Any suitable number or types of microservices may be used.

In block 220, the cloud computing system 120 installs a testing tool 121, a performance tool 122, and a chaos tool 123 to use to test the application 111c. The tools 121, 122, 123 may be installed on an application testing module 125 of the cloud computing system 120 or via any other type of module, device, network, pod, container, or operation of the cloud computing system 120. The operations of each tool 121, 122, 123 will be discussed in the method herein. The tools 121, 122, 123 may be installed by an operator of the cloud computing system 120, by a third-party operator, by an operator of the application provider computing system 130, or by any suitable party. The tools 121, 122, 123 may be three functions of a single tool that is installed on the cloud computing system 120. That is, the tools 121, 122, 123 may be operated by a single program or software such as the application testing module 125, receive inputs from a single user interface, operate on a single container, or interact together in any suitable manner. The single application testing module 125 may schedule, manage, and operate the three tools 121, 122, 123 in conjunction with one another to prevent conflicts or resource depletion.

Chaos testing and performance testing are performed by different tools because chaos testing and performance testing are different tests that use different processes to achieve different results. Chaos testing assesses system resilience to failures and disruptions. Performance testing evaluates system efficiency and responsiveness under expected conditions.

In examples, chaos testing uncovers weaknesses in fault tolerance and resilience by using fault injection and introducing controlled failures and disturbances. The goal of chaos testing is to identify vulnerabilities and improve fault tolerance to improve the system reliability and resilience. Performance testing determines system efficiency, speed, and responsiveness using load testing, stress testing, scalability testing, and other suitable performance tests. The goal of performance testing is to ensure that the system meets performance requirements to guarantee optimal performance under expected workloads.

Chaos testing is typically conducted in production or production-like environments to simulate real world conditions. Chaos testing typically uses destructive testing that intentionally introduces failures. The introduced scenarios can be highly variable and may involve randomness. The tests may be run continuously to assess system reliance over time. Chaos testing focuses on metrics related to error rates, recovery times, and system stability during failures. Chaos testing addresses broader system behavior during failures, including fault tolerance and recovery. In an example, chaos testing is suitable for systems that require high reliability and fault tolerance, such as critical infrastructure. Chaos testing is typically performed after functional testing to assess system behavior under adverse conditions. Chaos tests are scenario-based and involve designing specific chaos experiments and are primarily focused on assessing the system's ability to recover and maintain functionality despite failures. Chaos testing typically utilizes the setup of complex test environments to simulate various failure scenarios accurately.

Performance testing is often conducted in staging environments before an application is deployed. Performance testing is non-destructive and measures performance under load. Performance testing, emulates expected user load, interactions, and data volume. The scenarios used in performance testing are typically deterministic and predefined, and the tests are typically operated for specific durations to measure performance metrics. The metrics may include response times, throughput, resource utilization, and scalability metrics. Performance testing is frequently conducted during development cycles to identify performance issues early in the service life of an application to ensure that the application meets performance requirements. Performance testing is usually conducted as part of the testing pipeline with functional testing and integration testing. The tests are typically based on load profiles in user behavior patterns and concentrated on evaluating how efficiently system resources are utilized under various load conditions. Performance testing is typically not performed in production environments and typically involves predefined test, data sets and load profiles.

In block 230, the cloud computing system 120 provides a testing user interface 132 to the application provider computing system 130. The testing user interface 132 may be any suitable graphical user interface or other interface to allow an operator of the application provider computing system 130 to access the application testing module 125, configure the tools 121, 122, 123, monitor the testing, or perform any other suitable functions. The testing user interface 132 may be installed by an operator of the cloud computing system 120, by a third-party operator, by an operator of the application provider computing system 130, or by any suitable party.

In block 240, the cloud computing system 120 receives operational testing inputs from the user interface 132 and performs testing. An operator of the application provider computing system 130 enters settings or directions into the operator interface 132 to manage the testing and startup of the application 111c. For example, the operator selects from a menu of testing options to configure the tests to be run on the application 111c. The tests may include any combination of the testing processes described herein or other suitable testing processes.

In another example, the settings or directions are entered by a machine learning algorithm, and artificial intelligence, or other process, software, or program that determines what testing services should be provided.

When performing the testing inputs, the testing tool 121 is configured to validate the functionality of the microservices of the application 111c. The testing tool 121 operates each microservice separately to confirm that each microservice is configured properly to perform its function. The testing tool 121 may perform structural testing of each microservice. The testing tool 121 operates each microservice jointly with one or more other microservices to confirm that each microservice is configured properly to perform its function when the application 111c as a whole is operating. That is, a microservice may operate appropriately when testing alone, but may not perform appropriately when interacting with one or more other microservices. In an example, the testing tool 121 will simulate some or all of the functions of the microservices and monitor the results of the simulations to determine if expected and preferred outcomes are achieved. The testing tool 121 may operate the microservices under any suitable conditions to simulate real world applications.

In alternate embodiments, the testing tool 121 operates while the system is operational. The testing tool 121 monitors the performance of the microservices as the microservices are performing tasks for users. When functional or other errors are noted, the testing tool 121 logs the error and provides a notification of the error, such as by providing a notification on the user interface 132.

In block 250, the cloud computing system 120 receives performance testing inputs from the user interface 132 and performs testing. An operator of the application provider computing system 130 enters settings or directions into the testing operator interface 132 to manage the performance testing and startup of the application 111c. For example, the operator selects from a menu of performance testing options to configure the tests to be run on the application 111c. The performance tests may include any combination of the testing processes described herein or other suitable testing processes.

In another example, the settings or directions are entered by a machine learning algorithm, and artificial intelligence, or other process, software, or program that determines what performance testing services should be provided.

When conducting performance testing, the performance tool 122 determines the operational limits of the microservices or other functions of the application 111c. For example, the performance tool 122 may load one or more functions of a microservice until the microservice stops performing, such as due to a lack of processing capacity. The performance tool 122 may make repeated requests for a service faster than the microservice can perform the service. The microservice may have a failure or delay due to the backlog of requests. In another example, two or more microservices receive requests to interact with one another to perform a function. The requests require more processing capacity than the two or more microservices are capable of fulfilling. The two or more microservices may experience a delay or failure. Any other type of overloading of the system of the application 111c may be imposed to induce a failure.

When the performance tool 122 causes a failure, the performance tool 122 can log the limits of the application 111c. With the knowledge of the limits, an operator of the cloud computing system 120 or the application provider computing system 130 may limit future functions of the application 111c to prevent overloading or perform any other action based on the determined limits.

In block 260, the cloud computing system 120 receives chaos testing inputs from the user interface 132 and performs testing. An operator of the application provider computing system 130 enters settings or directions into the testing operator interface 132 to manage the chaos tool 123 and perform testing of the application 111c. For example, the operator selects from a menu of chaos testing options to configure the tests to be run on the application 111c. The chaos tests may include any combination of the testing processes described herein or other suitable testing processes.

In another example, the settings or directions are entered by a machine learning algorithm, and artificial intelligence, or other process, software, or program that determines what chaos testing services should be provided.

The method 260 of block 260 is described in greater detail with respect to FIG. 3. FIG. 3 is a block flow diagram of a method 260 to receive chaos testing inputs from user interface and perform resiliency and chaos testing.

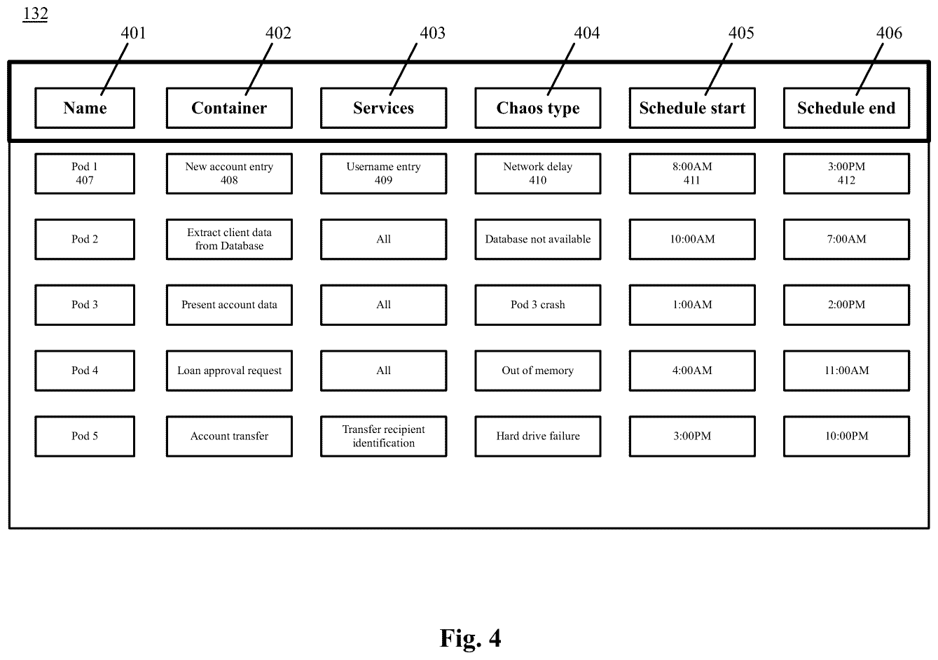

In block 310, a user enters selections of chaos elements and times for deployment of the elements. The user accesses a graphical testing user interface 132 that is displayed on a device of the application provider computing system 130. The details of the testing user interface 132 are illustrated in greater detail with respect to FIG. 4.

FIG. 4 is an illustration of an example testing graphical user interface 132. The user interface 132 is illustrated with six entry categories: name 401, container 402, services 403, chaos type 404, schedule start 405, and schedule end 406. Each category is fillable by a user via a text entry, a pull-down menu selection, an autofill selection, or any other type of entry. Each entry row specifies a type of chaos to implement.

In an example, in the first row, an entry is configured for Pod 1 407. The name 401 of the pod is Pod 1. The pod is a module or element of the cloud computing system 120 that hosts one or more containers for microservices. The next entry specifies the container 402 in Pod 1 labeled “new account entry” 408. The next entry is the microservice 403 within the container that is being modified to provide chaos to the system. The microservice selected is username entry 409. The next entry is the chaos type 404 that is being introduced. In the example, the type of chaos is a “network delay” 410. The next entries are for the schedule start 405 and schedule end 406. The time entered for the schedule start 405 is 8:00 AM 411, and time entered for the schedule end 406 is 3:00 PM 412.

Based on the entries, starting at 8:00 AM and ending at 3:00 PM, the username entry microservice will not perform normally because of a real or simulated network delay causing the new account entry container to experience an upset condition. As illustrated, any other number of chaos elements may be scheduled to occur simultaneously, subsequently, or both.

In other examples, chaos simulations may introduce any suitable chaos types, such as database not available, Pod crashes, out of memory, hard drive failures, network failure, latency injector, toxy proxy, network outage, timeouts, packet loss, bytecode fault injection, filesystem failures (I/O delay, I/O error), container failures, CPU overload, RAM/Memory attack, middleware failures/latency (TIBCO, Kafka, Solace), queue buffer, slow consumer, file size, or fan out. Any other type of chaos may be introduced to the system to test the response. All these chaos types can be integrated seamlessly into the Dev/QA/UAT infrastructure and can be executed via an industry standard CI/CD pipeline.

Example Cloud Native Experiments may include items from Table 1.

TABLE 1

| EXPERIMENT | DETAIL |
|---|---|
| Byte code injection | Profile the application under test and randomly inject |
| | captured exceptions, segmentation faults and latency |
| | directly in the running application code |
| Kill running service(s) on the | Kill a running service of the application ungracefully |
| pod ungracefully | (akin to kill −9 or OOM kill) |
| Kill running pod/container | Evict an application's pod and container randomly |
| Spike system resources such | Hog the pod/container memory/CPU to 100% where the |
| as RAM, CPU | application is running |
| Loss of disk space | Cause full disk space in pod/container where the |
| | application is running |
| Node failure | Forcefully Evict the worker nodes of the cloud |
| | orchestration platform |
| Database failure and latency | Cause disconnects and latency to database from where |
| | the application communicates |
| Middleware disconnects and | Cause failures and latency to the supporting middleware |
| latency | of the application (such as Solace, Tibco) |
| Network disruption | Simulate loss of network, packet drops, corrupt packets, |
| | connection refusals, etc. |
| Scheduled chaos experiments | Simulate any of the above singularly or in combination |
| | at a scheduled time preferred by the user |
| Chaos Experiments and | Targeted chaos experiments on a swarm of cloud native |
| Machine Learning | microservices using ML techniques based on real world |
| | scenarios and based on weaknesses identified as part of |
| | modelling performance and functional tests |

Returning to FIG. 3, in block 320, the chaos tool 123 schedules each chaos element entered into the user interface 132 and any automated chaos elements. When the user enters the chaos elements into the user interface 132, the chaos tool 123 logs the requests and prepares the chaos element software, hardware, module, function, or other required elements to implement the chaos element.

Normal execution of application code can be captured via profiling and the captured code path can then be broken automatically by the tool. An example of computer code to break the normal execution of the application 111c to mimic the chaos scenario chosen may be performed by the tool by intercepting the “readFile” method and causing it to throw an IOException at entry.

Latency in the running application can be accomplished by adding a wait at entry or exit in the “readFile” method. An example is presented below:

```
public void readFile(String fileName) {
try (FileInputStream fis = new FileInputStream(new File(fileName))) {
  BufferedReader br = new BufferedReader(new InputStreamReader(fis));
  String line;
  while ((line = br.readLine( )) != null) {
    logger.log(Line);
    processFileData(Line);
  }
  Fis.close( );
} catch (I0Exception e) {
  handleException(e);
}
}
```

Another example triggers a segmentation fault at OS level or OutOfMemoryError in the running application by randomly allocating or freeing memory in the below code at runtime and monitor the performance of the application. These features can be achieved by the tool in an automated process by capturing/submitting exceptional behavior with minimal human intervention.

public void freeMemory(long address) {
| UNSAFE.freeMemory(address);
}
public long allocate(long size) {
| long address = UNSAFE.allocateMemory( l: size*BYTESIZE);
| if (address == 0) {
| | throw new OutOfMemoryError( s: ″Free native memory not
| | available|″);
| } else {
| | return address;
| }
}

In block 330, the chaos tool 123 introduces each chaos element to the system and monitors the response and recovery of the system. When the time for each scheduled chaos element arrives, the chaos tool 123 injects the chaos into the system by initiating a software function, disabling software or hardware in the system, injecting code into a software element, forcing a setting to change, or performing any other suitable action to cause the requested chaos. Different chaos elements may happen to different microservices at the same time, overlapping in time, sequentially, or in any other suitable mix and match time selections.

The chaos tool 123 monitors the response of the affected microservices, the container, the pod, and the system as a whole. For example, the network delay 410 associated with the username entry 409 may cause one or more systems to fail. Users trying to access a new account entry may be unable to enter the required username. This failure may cause a cascading effect that causes other systems to fail. For example, if a user is unable to enter a username, then transactions that are scheduled may also fail. In another example, a microservice to which a chaos element is directed might not fail, but other microservices that interact with the affected microservice may fail because of changes in the operations of the affected microservice. For example, if an affected microservice is unable to access a database due to a chaos element interrupting the communication between the microservice and the database, the affected microservice may still operate normally, but other microservices that depend on the affected microservice to perform tasks associated with the database may fail.

In block 340, the chaos tool 123 logs failures and system weaknesses. The chaos tool 123 monitors the failures or other problems caused by the chaos. Each microservice, container, application 111c, or other system that fails or is adversely affected by the chaos element are logged by the chaos tool 123.

In the continuing example, the chaos tool 123 recognizes that the system does not fail due to the network delay 410. For example, the username entry 409 accesses the required data in another manner, such as from a different network. In this example, none of the systems fail due to the chaos.

The chaos tool 123 may recognize that the system is able to recover from the failure. Even if the system does temporarily fail, the microservice, or the system as a whole, is able to recover from the failure, such as by fencing off the failure from the rest of the application 111c, finding alternative mechanisms to perform required tasks, rebooting the failing microservice or device, or performing any other suitable tasks to recover from the failure.

When the schedule end 406 time is reached, the chaos tool 123 ends the scheduled chaos element. For example, the chaos tool 123 stops or deletes the injected software element that caused the chaos. The chaos tool 123 monitors the application 111c to determine if the application 111c is able to recover to normal operations when the chaos ends. The chaos tool 123 may log the actions taken by the application 111c during the chaos and after the chaos to determine the effectiveness of each action.

In an example, the logs of the events during the chaos scenario may be captured by the pod or by another microservice residing in the affected pod. The microservice may log the activities during the chaos scenario and communicate the activities to a user interface or other tool, such as the chaos tool 123, for review and inspection by a user or by a machine learning algorithm.

In block 350, the chaos tool 123 recommends recovery systems. When the chaos tool 123 identifies effective actions taken by the application 111c during and/or after the chaos, the chaos tool 123 logs the actions for future use. The chaos tool 123 may implement the effective action for use in other applications or systems. If actions taken were ineffective, the chaos tool 123 logs the ineffective actions for future use. The chaos tool 123 may implement different actions for use in the application 111c other applications or systems based on the ineffectiveness of the action.

In an example, if a machine learning algorithm is employed to build a model of the application 111 or other related systems, the results of the chaos scenario are entered into the input of the machine learning algorithm. The machine learning algorithm may use the model of the application to simulate actions to mitigate the chaos or recover from the chaos. As more data is input into the machine learning algorithm, the model become more predictive of responses to chaos inputs.

From block 350, the method 260 returns to block 270 of FIG. 2.

In certain examples, some or all of the steps of the chaos testing or the other described testing may be performed by a machine learning system. Because the chaos testing in certain examples is performed by the machine learning system based on testing data and simulations collected by the data acquisition system, human analysis or cataloging is not required. The process is performed automatically by the machine learning system without human intervention, as described in the Machine Learning section below. The amount of data typically collected by the machine learning system to use as inputs for analysis may include many millions of data points related to the operations of the systems under normal and abnormal circumstances. Human intervention in the process is not useful or required because the amount of data is too great. A team of humans would not be able to catalog or analyze the data in any useful manner to create chaos test parameters as described.

A chaos test becomes increasingly complex as more real-world scenarios are incorporated in the training data. These real-world events may include market open data, market closed data, pre-market hours, application green zone/red zone, market data volatility, or any other data. The fault scenarios may include pod crashes, network delays, database unavailable occurrences, Tibco/Solace downtime, out of memory issues, and network card or hard drive failures.

The machine learning system incorporates these real-world scenarios as training data. Data about the real-world scenarios, such as conditions, outcomes, attempts to correct, metadata, user actions, causes, and any other data related to failures or upsets from real-world situations are input into the machine learning system. The machine learning system analyzes the real-world scenarios to look for subtle, unobservable relationships, correlations, causations, trends, patterns, or other characteristics of the scenarios. The machine learning system learns how the systems interact in chaos scenarios and uses that knowledge to design new chaos scenarios.

The complex systems of an application are combined with the many microservices that are part of any complex cloud-based application. Attempting to perform these tasks manually would require multiple permutations and combinations of these factors. Humans are incapable of devising valid scenarios in more complex scenarios due to the multitudes of microservices at play. The interactions of the potentially thousands of microsystems create a network with a complexity that a human is unable to grasp. Without the understanding of the entire network of microservices, applications, networks, and users, proper useful chaos scenarios are unable to be developed that fully test an application.

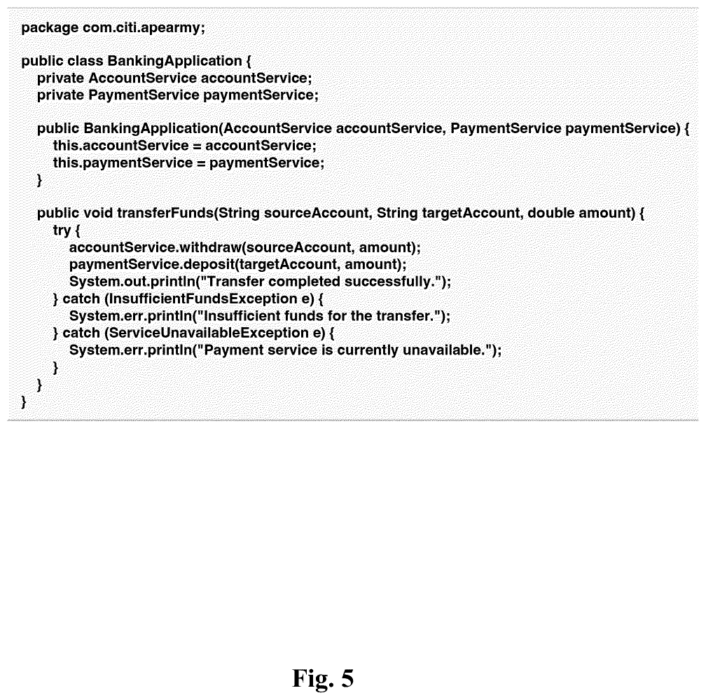

Details of the machine learning process to perform these tasks and functions are found in greater detail beginning with FIG. 5.

In block 270, the application 111 is updated based on the results of the testing. For example, an operator of the application provider computing system 130, the cloud computing system 120, or any other suitable system or operator may revise the application 111 based on the results of the three testing tools operated on the cloud computing system 120. The application 111a may be updated and uploaded to the cloud computing system 120 to update or replace the existing application 111c.

In certain examples, the testing of the application 111c described in FIG. 2-3 occurs while the application 111c is operating live. That is, users may be accessing the application 111a on user computing devices 110 and employing the application 111c to provide data or services while the testing is occurring. By performing the tests while operating live, the system is better able to identify problems because real world conditions are being processed simultaneously. In an alternate example, the testing of the application 111c described in FIG. 2-3 occurs while the application 111c is offline or not live. The testing may occur in a configuration environment or testing environment where users are not accessing the application 111c during the testing.

The combination of a testing tool 121, performance tool 122, and a chaos tool 123 as a single tool, application testing module 125, operating on the cloud computing system 120 combines all aspects of testing an application built on Kubernetes operator model and a user interface 132 to simulate the scenarios described herein making a combination tool capable of testing complex systems in the cloud environment. The novel Kubernetes operator combines functional and chaos scenario emulation in a single product with a rich user interface 132 built. The chaos tool 123 for implementing chaotic scenarios in complex trading applications is based on monolith/microservices architecture.

Many current applications or trading systems are hosted on Kubernetes or Openshift orchestrating platforms. Running chaos experiments via a separate user interface 132 requires a learning curve, navigating through deployment constraints within a business's internal infrastructure, and may not reside seamlessly within the ecosystem of trading applications.

The chaos tool 123 application user interface 132 features have been developed using the “Openshift Dynamic plugin” whereby the chaos tool 123 is created and deployed at run time in Openshift itself. This user interface 132 feature allows the user to interact with the application services residing in pods/containers directly in Openshift without having to navigate to, deploy or manage two different user interfaces. This eliminates the requirement of learning any new chaos tools as familiarity with Openshift translates into intuitiveness while using the chaos tool software. No special steps are needed to make the chaos engineering software compatible with the application under test.

As part of injecting chaotic scenarios, the system simulates certain conditions within the application being tested that may not be feasible via normal regression tests, such as exceptions, latencies, and other interruptions. Via the chaos engineering tool, a system may make the application behave in a certain way (such as making certain methods of a class perform an unexpected action) and then check the deviation from the steady state and observe the behavior of orders/trade within the trading application.

The chaos tool 132 performs the tasks described via “bytecode injection,” without having the need to modify, recompile or restart the application under test. Once the experiment is completed, the injected bytecode can be easily removed and the application 111c returned to steady state for analysis. Development of the chaos engineering tool has been done using Openshift's operator pattern that allows complete automation of creation, configuration, and management of the cloud native chaos engineering software.

End users only need to focus on conducting chaos experiments within the Openshift cluster while the operator performs the injecting of byte code, process restarts, and other faults within the trading application. The system provides an ability to expose chaos experiments as Custom Resource Definitions (CRDS). The system provides an ability to integrate the Chaos Experiments CRD in CI/CD pipeline as part of software development lifecycle Shift Left.

The system provides an ability to schedule and orchestrate chaos across multiple applications deployed on same cluster. Operator Experimentations Environment configuration may be through fully configurable Kubernetes ConfigMaps and shared volumes. The system provides seamless integration with BDD/Cucumber/Gherkin to allow Chaos Experiments to be run throughout any phase of the Software Development Life Cycle.

In certain applications, a machine learning algorithm, artificial intelligence process, or other automated network system may operate the application testing module 125, the chaos tool 123, the testing user interface 132, or any other functions or devices of the system. For example, when tests are performed on the application 111 or any other applications, the results of the testing may be stored by a machine learning system and a model of the application may be created. The model may be used to predict how the application 111 would function under certain testing or operating conditions. The model may be updated and improved with additional testing data from the application 111 or any other applications. The model may recommend, based on the expected performance of the application 111, which chaos tests should be performed. For example, if the model has insufficient data for a newly installed microservice, the model may recommend chaos tests that are likely to affect the new microservice. The model may populate the user interface 132 with chaos testing parameters that are associated with the desired chaos testing for the new microservice. The machine learning system may update the model with the results of the new chaos tests.

A typical example to use the platform in a BDD/Plain English format is presented below. The example presents order and trade flow in a trading application comprising three layers-client connectivity layer, Algo layer and Exchange Connectivity layer. A normal functional test would comprise validating the order flow in a When/Then format and would be the base test covering a single end-to-end event for an order flow. The user can then add steps to describe failure points that may happen during the order/trade flow to depict resiliency and chaos events.
1 @Functionality Test #Run only order and trade message steps with chaos, resiliency and performance disabled
2 @Resiliency Test #Kill configurable or random pods and nodes
3 @ChaosTest #Inject chaos, e.g. database, network failure, bytecode injection, system resource spike
4 @PerformanceTest #configure test repeatability e.g. run the test IM times and inject chaos randomly after nth order
5 @Combination Test #configure all or any of the above to run
6 Feature: Check the order and trade flow message in a Front Office Trading Platform
7 Scenario: Check the order and trade flow message in a Front Office Trading Platform
8 #Test Simulation
9 When Client sends an order message to ClientConnectivity layer
10 #Run this step only when @ChaosTest is selected
11 When VeeRa inject OutOfMemoryError in Algo Layer for ChaosTest
12 #Test Validation
13 Then Client Connectivity layer receives the order message and sends to Algo layer
14 #Run this step only when @ResiliencyTest is selected
15 When VeeRa kill ExchangeConnectivity pod for ResiliencyTest
16 #Test Validation
17 Then Algo layer receives the order message and sends to ExchangeConnectivity layer
18 #Run this step only when @ChaosTest is selected
19 When VeeRa inject NetworkDisconnect in ExchangeConnectivity layer for ChaosTest
20 #Test Validation
21 Then ExchangeConnectivity layer receives the order message and sends to Exchange
22 #Test Simulation
23 When Exchange sends a trade message to the ExchangeConnectivity layer
24 #Test Validation
25 Then Exchange Connectivity layer receives the trade and sends to Algo layer
26 #Run this step only when (a ChaosTest is selected
27 When VeeRa inject latency in ClientConnectivity Layer and database failure in Algo Layer for ChaosTest
28 #Test Validations
29 When Algo layer receives the trade and sends to Client Connectivity layer
30 Then ClientConnectivity layer receives the trade and sends to Client

Via the user interface in block 240, the test type can be chosen based on the Annotation used (shown with ‘@’). For example, if @FuntionalTest is used, the platform will run only the functional steps and disable all the resiliency/chaos steps. If @Resiliency Test is used, then the platform would enable the step in line 15. Using @ChaosTest would enable lines 11, 19 and 27. Using @PerformanceTest would keep running the same test a configurable number of times. Using @Combination would enable the platform to run the tests in a combined way, such as by injecting chaos after 1M orders have been entered as part of @Perfomance.

Via the blocks 250, 260 and 270, testing results based on the tests run as part of this alternate example of block 240 can be obtained.

The machine learning system may be used to perform, recommend, assist, or otherwise participate in any of the functions described herein, such as functional testing, performance testing, or chaos testing. While many of the examples herein are based on using machine learning systems for chaos testing, the machine learning systems may perform similar functions to improve functional testing and performance testing. For example, the machine learning system may be used to accomplish any other following objectives.

Anomaly Detection: the machine learning system may use algorithms to establish baselines for normal application behavior during chaos testing. The machine learning system may continuously monitor key performance metrics and system behavior and detect anomalies and deviations from expected behavior, such as increased latency or error rates. The machine learning system may perform the monitoring on application data and network data being provided as inputs to the machine learning system. The data may be received from the applications themselves, from the user computing device or from any suitable location. The data may include the conditions under which the application is operating, including any upset conditions such as network delays, power interruptions, or any other type of upset. The data may be compared to models of the application that were created using the machine learning system. When chaos tests are initiated, the machine learning system can predict how the application will react, even if the reaction is a failure. By comparing the actual reactions of the application to the predicted reactions, the machine learning system can identify anomalies or other diversions from the expected behavior. The machine learning system may trigger alerts or automated responses when significant anomalies are detected during chaos experiments.

Automated Chaos Scenario Selection: the machine learning system may leverage machine learning algorithms to intelligently select and prioritize chaos scenarios. The machine learning system may analyze historical chaos testing results to identify weak points and areas of vulnerability. The machine learning system may use machine learning-driven decision-making to determine which chaos experiments to run and when to optimize resource utilization and testing coverage. The historical chaos results may be from designed or scheduled chaos scenarios or from actual upset conditions. The machine learning system may determine how each chaos scenario affects the operation of the system and determine how the chaos scenarios interact with each other. The machine learning system analyzes the historical chaos testing results to look for subtle, unobservable relationships, correlations, causations, trends, patterns, or other characteristics of the scenarios. The machine learning system learns how the systems interact in chaos scenarios and uses that knowledge to design new chaos scenarios. The chaos scenarios may be designed to achieve a certain goal or just to inspect the effects of the chaos scenarios. For example, the machine learning system may attempt to create a chaos scenario that causes complete system failure to understand how the system will perform a shutdown under failure conditions. The machine learning system may provide multiple chaos scenarios to allow an operator to make a selection of one or more scenarios. By understanding the intricate relationships between the chaos elements, the machine learning system can design a series of chaos actions that will cause different types of failures. For example, the machine learning system can plan consecutive, concurrent, or subsequent actions that will cause a cascade effect on the application or the entire network. These cascading effects can be modeled in the machine learning system in a way that is too complex for a human operator to grasp. For example, the machine learning system may model the effects of five chaos conditions on 30 different microsystems of an application occurring concurrently and predict if this chaos scenario would be a useful test of the application.

Failure Prediction: the machine learning system may train models to predict potential system failures or instability during chaos testing. The machine learning system may analyze historical data and failure scenarios to identify patterns leading to performance degradation or outages. The machine learning system may proactively address identified risks and weaknesses to prevent failures.

Adaptive Chaos Engineering: the machine learning system may implement adaptive chaos engineering using machine learning models. The machine learning system may dynamically adjust the intensity and scope of chaos experiments based on real-time system behavior. The machine learning system may optimize chaos testing scenarios to strike the right balance between risk and resilience. When a chaos testing scenario is initiated by the machine learning system, the machine learning system monitors the impact of the chaos in real-time. That is, the status of the application or network that is being impacted is provided to the machine learning system as inputs. The machine learning system monitors the status and compares the status to the expected chaos outcomes, the normal operational status, or both. The machine learning system is able to determine the effect of the chaos as the system is experiencing the upset conditions.

The machine learning system is able to revise the chaos scenario in real time based on the effects of the chaos. That is, if the chaos is not having a desired effect on the application, then the machine learning system may make the chaos worse or different. For example, if the chaos implemented is a network delay, the machine learning system may observe that the chaos is not affecting the application negatively. The machine learning system may revise the chaos by making the network delays longer or adding an additional upset condition, such as a surge of users. The new upset conditions may be increased until the application fails. A human could not observe thousands of inputs of real time data, process the implications of the data, and revise the chaos scenario in real time based on the implications.

Recommendation Engines: The machine learning system may develop recommendation engines driven by machine learning insights. The machine learning system may suggest improvements and optimizations based on chaos testing outcomes. The machine learning system may provide actionable recommendations to enhance the application's resilience and performance. Based on the historical chaos testing data, the machine learning system learns how each system reacts to different chaos scenarios. By understanding how each microsystem or application reacts to the upset conditions, the machine learning system can develop strategies for dealing with chaos. The recommendations may be provided to an operator of other user via a user interface of the machine learning system or other system.

For example, if the machine learning system learns that a user login microservice will time out after 20 seconds during a network delay, the machine learning system may recognize that a longer time out period for that microservice is needed if another microservice recognizes a network delay is imminent. The machine learning system will provide a recommendation to an operator or other user to increase the time out period when certain conditions are present or expected.

Data-Driven Analysis: The machine learning system may analyze chaos testing data using machine learning techniques to uncover patterns and insights. The machine learning system may identify the impact of chaos experiments on various system components. The machine learning system may use machine learning to determine which components are more susceptible to failures and need further testing.

Performance Optimization: The machine learning system may utilize machine learning algorithms to optimize application performance during chaos testing. The machine learning system may dynamically adjust resource allocation and scaling strategies based on real-time performance data. The machine learning system may optimize load balancing and routing decisions to maintain application stability under chaotic conditions.

Continuous Learning: The machine learning system may continuously update machine learning models with new data from chaos testing. The machine learning system may adapt models to evolving application behavior, market conditions, and user activity. The machine learning system may regularly validate and refine machine learning models to improve their accuracy in predicting chaos-related issues. The continuous data may be received from any system component. The continuous data may be received after chaos testing is executed or from real-world upset conditions. Any source of data may be used to further expand the machine learning system's knowledge and understanding of the connections and patterns of the network and the applications.

Failure Analysis: The machine learning system may employ machine learning techniques for post-chaos test analysis. The machine learning system may automatically analyze chaos testing results and identify root causes of failures or performance issues. As discussed herein, the machine learning system has processed the input data received from the operations of applications, individual microservices, the network, user computing devices, or any other components. Based on the dependencies mapped, the chaos testing executed, the real-world upsets experienced, and any other data, the machine learning system develops models of each component that are predictive and representative of how the components will react given certain conditions. When chaos testing is performed and the application is in failure mode, the machine learning system analyzes the application, the status of each component during the chaos testing, the performance of each component during the chaos, the effects of the chaos downstream of the component, or any other feature that was tested. The machine learning system may determine where and when the failure occurred. The machine learning system may determine what triggered the failure. The machine learning system may determine how the failure might be avoided in future upset conditions.

The machine learning system may accelerate incident response and troubleshooting using AI-driven insights.

Scalability Testing: The machine learning system may use machine learning models to simulate and predict the impact of increased load and scalability issues during chaos testing. The machine learning system may evaluate the system's ability to handle peak trading volumes and bursts of traffic.

The machine learning system may further be integrated with the GIT source code repository to analyze the source code of the application. The machine learning system may be used to analyze the code of an application in generate chaos test scenarios. The machine learning system may perform this function by utilizing natural language processing (“NPL”) techniques to analyze code comments, documentation, and the code itself to understand the applications architecture, dependencies, and critical components.

FIG. 5 is an illustration of code to devise a chaos scenario. In this example, the machine learning system will parse a Java class and devise a chaos engineering scenario.

In the example, the system is a financial application, but any other type of application may be represented. The application may be a social media application, a data transfer application, a secure access application, an insurance claim application, or any other suitable application. This example code structure is highly simplified and an actual real-world scenario would typically be more complex.

In the example, the BankingApplication provides methods for transferring funds between accounts. The class uses AccountService and PaymentService for these operations and handles exceptions like InsufficientFundsException and Service UnavailableException.

The machine learning system may parse this class and suggest a chaos engineering scenario. An example of this process is described as follows.
a) Parsing the Java Class: The machine learning system would first parse the Java class BankingApplication to understand its structure, methods, and dependencies.
b) Identifying Service Dependencies: The machine learning system can identify that the BankingApplication class relies on AccountService and PaymentService for fund transfers.
c) Detecting Points of Failure: The machine learning system can analyze the code and recognize potential points of failure. In this case, the machine learning system might identify that a failure in the AccountService or PaymentService can disrupt fund transfers.
d) Generating Chaos Scenario: Based on this analysis, the machine learning system can suggest a chaos engineering scenario. The scenario might be as follows:
Scenario: Chaos Test: Payment Service Failure During Fund Transfer
Description: Simulate a scenario where the Payment Service becomes unavailable during a fund transfer operation. Steps: 1) Initiate a fund transfer from one account to another using the BankingApplication. 2) Introduce a simulated failure in the PaymentService, causing it to throw a ServiceUnavailableException. 3) Verify how the BankingApplication handles this failure, whether it logs errors, retries the operation, or takes any corrective actions.
e) Documentation and Reporting: The machine learning system can generate documentation for this chaos scenario, including its purpose, steps, and expected outcomes. The machine learning system can also create a report outlining the potential risks and resilience of the application under this scenario.
f) Integration with Chaos Engineering Platform: The generated chaos scenario can be integrated into a chaos engineering platform for execution during testing.

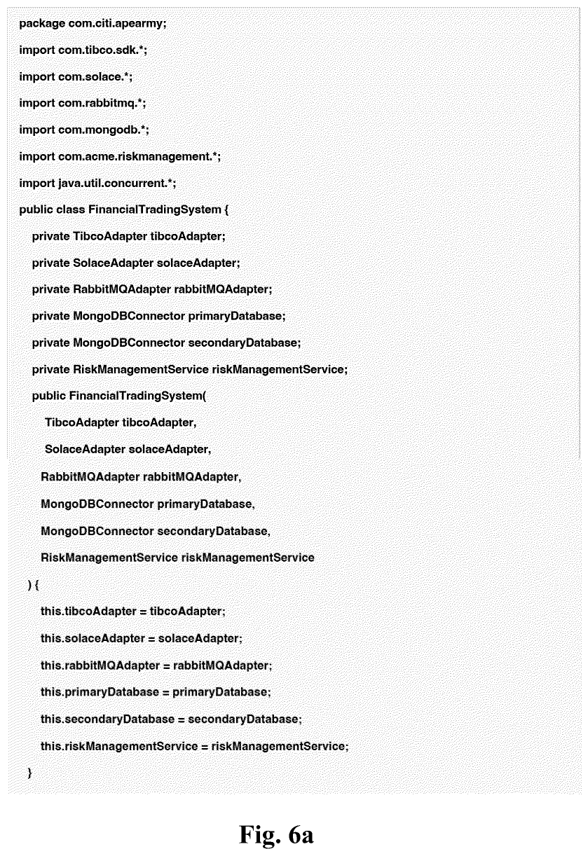

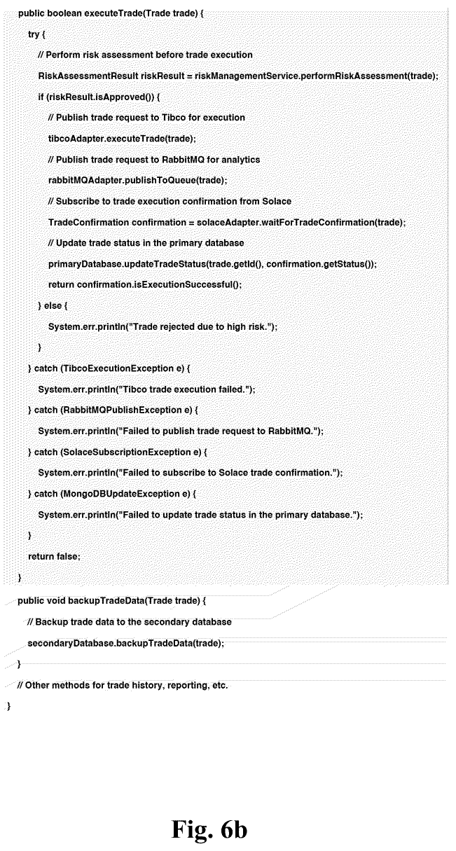

FIGS. 6a and 6b is an illustration of code to devise a chaos scenario. In the example, the system is a financial trading system. This example code structure is highly simplified and an actual real-world scenario would be more complex.

The machine learning system may parse this class and suggest a chaos engineering scenario. An example of this process is described as follows.
a) Parsing the Java Class and Configurations: The machine learning system parses the FinancialTradingSystem class, including the additional business logic, and associated configurations to understand the class's methods, external service dependencies, risk management, and exception handling.
b) Identifying External Service Dependencies and Risk Components: The machine learning system recognizes that the application relies on Tibco, Solace, RabbitMQ, primary and secondary MongoDB databases, and a risk management service for trade processing, messaging, data storage, risk assessment, and analytics.
c) Detecting Points of Failure and Risk Scenarios: the machine learning system identifies potential points of failure, complex risk scenarios, and exceptions, including those related to trade execution, message queue publishing, risk assessment, and database updates.
d) Generating Complex Chaos Scenario: the machine learning system suggests a complex chaos engineering scenario. The scenario might be as follows:
Advanced Chaos Test: Risk Assessment Failure and Concurrent Database Issues. Description: Simulate a scenario where the risk assessment service fails to respond during trade processing, and concurrent database issues occur with both the primary and secondary MongoDB databases.
Steps: 1) Initiate a trade execution request through the FinancialTradingSystem. 2) Introduce simulated failures: A) Risk assessment service becomes unresponsive, causing a RiskAssessmentTimeoutException. B) Both primary and secondary MongoDB databases experience connectivity issues, leading to MongoDBConnectionException. C) Observe how the application handles these complex failures, including trade rejection due to risk assessment failure and database issues.

The machine learning system may be used to improve other systems or perform other functions or tasks. Using one or more of the algorithms or systems described herein, the machine learning system can perform tasks such as the following.

Dependency Mapping: Use the machine learning system to automatically map out dependencies within the codebase, including libraries, APIs, and external services that the application relies on. The machine learning system may use histories of code and the results of the code to develop models or other systems to be used in analyzing the codebase. The models may be used to simulate actions taken by the application when experiencing different conditions. The models may be based on actual data received as input training data from existing applications and user devices. The models may analyze many thousands of applications and the millions of data points and metadata associated with the applications to generate the models that simulate how real-world applications behave.

The dependencies allow the models to understand how one action by a microservice of an application will affect any other dependent microservices. For example, if a microservice for authenticating a user is failing to process the authentication, then a microservice that allows the user access to a secure database is unable to proceed. Any other microservices that are dependent on the authentication are similarly impacted. The model is able to create a sequential set of dependencies for each microservice or function of the application.

Behavioral Analysis: Employ machine learning algorithms to analyze code behavior and execution paths. The machine learning system may identify potential points of failure or weak spots in the code that could be subjected to chaos testing. By gaining an understanding of how each function of the code, microservice, module, or other portion of the code is impacted by each type of chaos element, allows the machine learning system to predict which portions of the code are likely to be potential failure spots when one or more chaos elements are applied. For example, if a microservice for verifying a data transfer from a user computing device is impacted by network delays, then the machine learning system may determine that a chaos element that completely severs the network connection should be executed to determine how the microservice reacts.

Pattern Recognition: Train machine learning system models on historical code and test data to recognize patterns of code behavior that may lead to instability or failures.

Test Scenario Generation: Develop machine learning system algorithms that generate chaos test scenarios based on the code analysis. These scenarios can include injecting faults, introducing latency, or simulating resource constraints in areas of the code where vulnerabilities or potential issues are detected. The scenarios generated may be

Risk Assessment: Use the machine learning system to assess the risk associated with each generated chaos test scenario. The machine learning system may evaluate the impact of potential failures on the application's functionality and performance.

Prioritization: Implement machine learning-driven prioritization of chaos test scenarios based on factors such as code complexity, criticality of components, and historical failure data.

Dynamic Adaptation: Create machine learning system models that adapt chaos testing scenarios in real-time based on the evolving codebase and application behavior. When a chaos testing scenario is initiated by the machine learning system, the machine learning system monitors the impact of the chaos in real-time. That is, the status of the application or network that is being impacted is provided to the machine learning system as inputs. The machine learning system monitors the status and compares the status to the expected chaos outcomes, the normal operational status, or both. The machine learning system is able to determine the effect of the chaos as the system is experiencing the upset conditions.

The machine learning system is able to revise the chaos scenario in real time based on the effects of the chaos. That is, if the chaos is not having a desired effect on the application, then the machine learning system may make the chaos worse or different. For example, if the chaos implemented is a network delay, the machine learning system may observe that the chaos is not affecting the application negatively. The machine learning system may revise the chaos by making the network delays longer or adding an additional upset condition, such as a surge of users. The new upset conditions may be increased until the application fails. A human could not observe thousands of inputs of real time data, process the implications of the data, and revise the chaos scenario in real time based on the implications.

Continuous Learning: Continuously update machine learning system models with new code changes and testing results to improve the accuracy of scenario generation.

Automation: Integrate the machine learning system generated chaos testing scenarios into existing chaos engineering platform. Automate the execution of these scenarios and monitor the application's behavior during testing.

The machine learning system may use systems such as a large language model to perform certain tasks. A large language model is a deep learning algorithm that can perform a variety of natural language processing tasks. Large language models use transformer models and are trained using large datasets. This enables them to recognize, translate, predict, or generate text or other content.

Large language models are also referred to as neural networks (“NN”). NNs are a family of statistical learning models influenced by biological neural networks of the brain. NNs can be trained on a relatively-large dataset (e.g., 50,000 or more) and used to estimate, approximate, or predict an output that depends on a large number of inputs/features. NNs can be envisioned as so-called “neuromorphic” systems of interconnected processor elements, or “neurons”, and exchange electronic signals, or “messages”. Similar to the so-called “plasticity” of synaptic neurotransmitter connections that carry messages between biological neurons, the connections in NNs that carry electronic “messages” between “neurons” are provided with numeric weights that correspond to the strength or weakness of a given connection. The weights can be tuned based on experience, making NNs adaptive to inputs and capable of learning. For example, an NN for chaos testing results is defined by a set of input neurons that can be given input data such as previous testing results. The input neuron weighs and transforms the input data and passes the result to other neurons, often referred to as “hidden” neurons. This is repeated until an output neuron is activated. The activated output neuron produces a result. In example embodiments, previous testing results are used to train the neurons in a NN machine learning module, which, after training, is used to select which testing parameters would be useful in a generated chaos scenario.

In addition to teaching human languages to artificial intelligence (“AI”) applications, large language models can also be trained to perform a variety of tasks such as understanding protein structures or writing software code. Large language models are pre-trained by analyzing input data from any type of dataset. The large language models can be trained to solve analysis problems such as text classification, question answering, document summarization, and text generation problems. The large language models can be applied to fields like healthcare, finance, and insurance where large language models serve a variety of NLP applications, such as translation, chatbots, and AI assistants.

Large language models may be developed with deep learning architectures called transformer networks. A transformer model is a neural network that learns context and meaning by tracking relationships in sequential data, such as the sequence inherent in a sentence.

A transformer model may be composed of multiple transformer blocks, also known as layers. For example, a transformer may use self-attention layers, feed-forward layers, and normalization layers. The layers may be used to analyze inputs to predict streams of output. The layers can be used in combination to make deeper transformers and powerful language models.

Using a large language model as described herein or another similar machine learning or artificial intelligence technology, the machine learning system can perform tasks such as the following.

Test Scenario Generation: Utilize a large language model to assist in generating complex chaos test scenarios based on textual descriptions or high-level specifications. When a user describes the desired testing objectives or conditions in natural language, the model can generate detailed test scenarios based on the input. The large language model may analyze a dataset of past chaos scenarios, both generated scenarios and real-world occurrences. The large language model processes the input data, characterizes the data, and analyzes the sequences of events resulting from each scenario and occurrence.

The large language model may create models of systems and perform simulations to determine how different chaos situations may affect the systems involved. Based on the understanding of the systems and the potential chaos scenarios, the large language model can suggest a set or series of chaos scenarios to test or inspect a system. The large language model may suggest, schedule, and/or execute the chaos testing as described herein, such as with respect to FIGS. 3 and 4.

Documentation Analysis: Analyze documentation and code comments using the language model to extract relevant information about the application's architecture, dependencies, and critical components. The large language model may use a generated model of an application to summarize documentation and identify key points related to chaos testing. As the large language model is able to analyze sentence structures and logical sequences, the large language model may be trained to understand the relevant information for the application. The large language model may use the summarized documentation and the key points to provide information to a user, further revise chaos strategies, and create new chaos scenarios.

Code Review Assistance: Employ the language model to assist in code reviews by providing insights, identifying potential issues, and suggesting improvements related to chaos resilience. The large language model may be used to review code changes and assess their impact on chaos engineering practices.

Natural Language Interfaces: Develop natural language interfaces and chatbots that allow teams to interact with a chaos engineering platform. Users can ask questions, request information about test scenarios, and receive explanations in plain language, enhancing collaboration. In the example, the natural language interfaces and chatbots may be executed on any suitable device. For example, a user of applications may interface with a chatbot on the user application on the user computing device. In another example, an operator of the application testing module may interact with the natural language interface on the chaos tool of the application testing module.

Documentation Generation: Use the language model to automatically generate documentation for chaos test scenarios, including descriptions, expected outcomes, and potential risks. The large language model may ensure that the chaos testing practices are well-documented and easily accessible to team members. For example, the documentation that is generated may be displayed to an operator on the chaos tool of the application testing module.

Scenario Validation: Leverage the language model to validate and verify the correctness of generated chaos test scenarios. The large language model may ensure that scenarios are logically sound and aligned with the intended testing objectives. Based on the understanding of the systems and the potential chaos scenarios, the large language model can simulate the scenarios to predict the outcome of each scenario. If a scenario will cause irreparable harm to the system, then the large language model may recommend not employing that chaos scenario. If a scenario is simulated and creates a usable level of chaos, then the scenario may be recommended for use.

Natural Language Reporting: Generate natural language reports summarizing the results of chaos tests, making it easier for users, customers, operators, or any other stakeholder to understand the impact and implications of testing.

Error and Anomaly Detection: Utilize the language model to assist in the interpretation of error messages and log data generated during chaos testing. The large language model may identify and categorize anomalies and errors based on natural language descriptions. When a chaos test is performed, the systems will encounter error messages and/or system data that indicates that one or more operations of the application are not operating as expected. The messages or data may be simply signals, computer outputs, halted operations, alarms, alerts, or any other type of recognizable error indication. The error indication may not be readable or understandable to an operator. The large language model may receive the error indication and convert the indication to an output that is readable by a human.

Knowledge Transfer: Use the language model to facilitate knowledge transfer within a user team by providing explanations, tutorials, and answers to questions related to chaos engineering practices.

ChatOps: Implement ChatOps practices by integrating the language model into chat platforms like Slack or Microsoft Teams. The large language model may enable real-time collaboration and communication regarding chaos testing activities.

### Machine Learning

Machine learning is a field of study within artificial intelligence that allows computers to learn functional relationships between inputs and outputs without being explicitly programmed.

The term “Artificial Intelligence” refers to a quantitative method, system, or approach (“techniques”) that emulates human intelligence via computer programs. These can be used to make estimates, predictions, recommendations, or decisions in manners that go beyond classical statistical, mathematical, econometric, or financial approaches.

Machine learning is the subset of AI that derives representations or inferences from data without explicitly programming every parameter representation or computer step (for example, Random Forest or Artificial Neural Network based algorithm approaches). In contrast, AI techniques that are not members of the machine learning subset include techniques such as fuzzy logic, complex dependency parsing techniques for natural language processing.

Machine learning involves a module comprising algorithms that may learn from existing data by analyzing, categorizing, or identifying the data. Such machine-learning algorithms operate by first constructing a model from training data to make predictions or decisions expressed as outputs. In example embodiments, the training data includes data for one or more identified features and one or more outcomes, for example using application parameters and assemblage of microservices to intelligently select and prioritize chaos scenarios. Although example embodiments are presented with respect to a few machine-learning algorithms, the principles presented herein may be applied to other machine-learning algorithms.

Data supplied to a machine learning algorithm can be considered a feature, which can be described as an individual measurable property of a phenomenon being observed. The concept of feature is related to that of an independent variable used in statistical techniques such as those used in linear regression. The performance of a machine learning algorithm in pattern recognition, classification and regression is highly dependent on choosing informative, discriminating, and independent features. Features may comprise numerical data, categorical data, time-series data, strings, graphs, or images.

In general, there are two categories of machine learning problems: classification problems and regression problems. Classification problems, also referred to as categorization problems, aim at classifying items into discrete category values. Training data teaches the classifying algorithm how to classify. In example embodiments, features to be categorized may include transaction data, which can be provided to the classifying machine learning algorithm and then placed into categories of, for example, transactions with payment instrument X, transactions at geolocation Y, or incentives provided that prompted a change in payment instrument. Regression algorithms aim at quantifying and correlating one or more features. Training data teaches the regression algorithm how to correlate the one or more features into a quantifiable value.

### Embedding

In one example, the machine learning module may use embedding to provide a lower dimensional representation, such as a vector, of features to organize them based off respective similarities. In some situations, these vectors can become massive. In the case of massive vectors, particular values may become very sparse among a large number of values (e.g., a single instance of a value among 50,000 values). Because such vectors are difficult to work with, reducing the size of the vectors, in some instances, is necessary. A machine learning module can learn the embeddings along with the model parameters. In example embodiments, features such as geolocation can be mapped to vectors implemented in embedding methods. In example embodiments, embedded semantic meanings are utilized. Embedded semantic meanings are values of respective similarity. For example, the distance between two vectors, in vector space, may imply two values located elsewhere with the same distance are categorically similar. Embedded semantic meanings can be used with similarity analysis to rapidly return similar values. In example embodiments, the methods herein are developed to identify meaningful portions of the vector and extract semantic meanings between that space.

### Training Methods

In example embodiments, the machine learning module can be trained using techniques such as unsupervised, supervised, semi-supervised, reinforcement learning, transfer learning, incremental learning, curriculum learning techniques, and/or learning to learn. Training typically occurs after selection and development of a machine learning module and before the machine learning module is operably in use. In one aspect, the training data used to teach the machine learning module can comprise input data such as chaos testing results and the respective target output data such as which testing parameters would be useful in a generated chaos scenario.

### Unsupervised and Supervised Learning

In an example embodiment, unsupervised learning is implemented. Unsupervised learning can involve providing all or a portion of unlabeled training data to a machine learning module. The machine learning module can then determine one or more outputs implicitly based on the provided unlabeled training data. In an example embodiment, supervised learning is implemented. Supervised learning can involve providing all or a portion of labeled training data to a machine learning module, with the machine learning module determining one or more outputs based on the provided labeled training data, and the outputs are either accepted or corrected depending on the agreement to the actual outcome of the training data. In some examples, supervised learning of machine learning system(s) can be governed by a set of rules and/or a set of labels for the training input, and the set of rules and/or set of labels may be used to correct inferences of a machine learning module.

### Semi-Supervised and Reinforcement Learning

In one example embodiment, semi-supervised learning is implemented. Semi-supervised learning can involve providing all or a portion of training data that is partially labeled to a machine learning module. During semi-supervised learning, supervised learning is used for a portion of labeled training data, and unsupervised learning is used for a portion of unlabeled training data. In one example embodiment, reinforcement learning is implemented. Reinforcement learning can involve first providing all or a portion of the training data to a machine learning module and as the machine learning module produces an output, the machine learning module receives a “reward” signal in response to a correct output. Typically, the reward signal is a numerical value and the machine learning module is developed to maximize the numerical value of the reward signal. In addition, reinforcement learning can adopt a value function that provides a numerical value representing an expected total of the numerical values provided by the reward signal over time.

### Transfer Learning

In one example embodiment, transfer learning is implemented. Transfer learning techniques can involve providing all or a portion of a first training data to a machine learning module, then, after training on the first training data, providing all or a portion of a second training data. In example embodiments, a first machine learning module can be pre-trained on data from one or more computing devices. The first trained machine learning module is then provided to a computing device, where the computing device is intended to execute the first trained machine learning model to produce an output. Then, during the second training phase, the first trained machine learning model can be additionally trained using additional training data, where the training data can be derived from kernel and non-kernel data of one or more computing devices. This second training of the machine learning module and/or the first trained machine learning model using the training data can be performed using either supervised, unsupervised, or semi-supervised learning. In addition, it is understood transfer learning techniques can involve one, two, three, or more training attempts. Once the machine learning module has been trained on at least the training data, the training phase can be completed. The resulting trained machine learning model can be utilized as at least one of trained machine learning module.

### Incremental and Curriculum Learning

In one example embodiment, incremental learning is implemented. Incremental learning techniques can involve providing a trained machine learning module with input data that is used to continuously extend the knowledge of the trained machine learning module. Another machine learning training technique is curriculum learning, which can involve training the machine learning module with training data arranged in a particular order, such as providing relatively easy training examples first, then proceeding with progressively more difficult training examples. As the name suggests, difficulty of training data is analogous to a curriculum or course of study at a school.

### Learning to Learn

In one example embodiment, learning to learn is implemented. Learning to learn, or meta-learning, comprises, in general, two levels of learning: quick learning of a single task and slower learning across many tasks. For example, a machine learning module is first trained and comprises of a first set of parameters or weights. During or after operation of the first trained machine learning module, the parameters or weights are adjusted by the machine learning module. This process occurs iteratively on the success of the machine learning module. In another example, an optimizer, or another machine learning module, is used wherein the output of a first trained machine learning module is fed to an optimizer that constantly learns and returns the final results. Other techniques for training the machine learning module and/or trained machine learning module are possible as well.

### Contrastive Learning

In example embodiment, contrastive learning is implemented. Contrastive learning is a self-supervised model of learning in which training data is unlabeled is considered as a form of learning in-between supervised and unsupervised learning. This method learns by contrastive loss, which separates unrelated (i.e., negative) data pairs and connects related (i.e., positive) data pairs. For example, to create positive and negative data pairs, more than one view of a datapoint, such as rotating an image or using a different time-point of a video, is used as input. Positive and negative pairs are learned by solving dictionary look-up problem. The two views are separated into query and key of a dictionary. A query has a positive match to a key and negative match to all other keys. The machine learning module then learns by connecting queries to their keys and separating queries from their non-keys. A loss function, such as those described herein, is used to minimize the distance between positive data pairs (e.g., a query to its key) while maximizing the distance between negative data points. See e.g., Tian, Yonglong, et al. “What makes for good views for contrastive learning?” Advances in Neural Information Processing Systems 33 (2020): 6827-6839.

### Pre-Trained Learning

In example embodiments, the machine learning module is pre-trained. A pre-trained machine learning model is a model that has been previously trained to solve a similar problem. The pre-trained machine learning model is generally pre-trained with similar input data to that of the new problem. A pre-trained machine learning model further trained to solve a new problem is generally referred to as transfer learning, which is described herein. In some instances, a pre-trained machine learning model is trained on a large dataset of related information. The pre-trained model is then further trained and tuned for the new problem. Using a pre-trained machine learning module provides the advantage of building a new machine learning module with input neurons/nodes that are already familiar with the input data and are more readily refined to a particular problem. See e.g., Diamant N, et al. Patient contrastive learning: A performant, expressive, and practical approach to electrocardiogram modeling. PLOS Comput Biol. 2022 Feb. 14; 18 (2): e1009862.

In some examples, after the training phase has been completed but before producing predictions expressed as outputs, a trained machine learning module can be provided to a computing device where a trained machine learning module is not already resident, in other words, after training phase has been completed, the trained machine learning module can be downloaded to a computing device. For example, a first computing device storing a trained machine learning module can provide the trained machine learning module to a second computing device. Providing a trained machine learning module to the second computing device may comprise one or more of communicating a copy of trained machine learning module to the second computing device, making a copy of trained machine learning module for the second computing device, providing access to trained machine learning module to the second computing device, and/or otherwise providing the trained machine learning system to the second computing device. In example embodiments, a trained machine learning module can be used by the second computing device immediately after being provided by the first computing device. In some examples, after a trained machine learning module is provided to the second computing device, the trained machine learning module can be installed and/or otherwise prepared for use before the trained machine learning module can be used by the second computing device.

After a machine learning model has been trained it can be used to output, estimate, infer, predict, generate, produce, or determine, for simplicity these terms will collectively be referred to as results. A trained machine learning module can receive input data and operably generate results. As such, the input data can be used as an input to the trained machine learning module for providing corresponding results to kernel components and non-kernel components. For example, a trained machine learning module can generate results in response to requests. In example embodiments, a trained machine learning module can be executed by a portion of other software. For example, a trained machine learning module can be executed by a result daemon to be readily available to provide results upon request.

In example embodiments, a machine learning module and/or trained machine learning module can be executed and/or accelerated using one or more computer processors and/or on-device co-processors. Such on-device co-processors can speed up training of a machine learning module and/or generation of results. In some examples, trained machine learning module can be trained, reside, and execute to provide results on a particular computing device, and/or otherwise can make results for the particular computing device.

Input data can include data from a computing device executing a trained machine learning module and/or input data from one or more computing devices. In example embodiments, a trained machine learning module can use results as input feedback. A trained machine learning module can also rely on past results as inputs for generating new results. In example embodiments, input data can comprise previous chaos experiment results and, when provided to a trained machine learning module, results in output data such as recommendations to intelligently select and prioritize chaos scenarios. The output can then be provided to the incentive system to use in determining what incentives to offer to certain users. As such, the identification-related technical problem of how to most efficiently and effectively apply chaos scenarios can be solved using the herein-described techniques that utilize machine learning to produce outputs of recommendations to intelligently select and prioritize chaos scenarios.

### Algorithms

Different machine-learning algorithms have been contemplated to carry out the embodiments discussed herein. For example, linear regression (LiR), logistic regression (LoR), Bayesian networks (for example, naive-bayes), random forest (RF) (including decision trees), neural networks (NN) (also known as artificial neural networks), matrix factorization, a hidden Markov model (HMM), support vector machines (SVM), K-means clustering (KMC), K-nearest neighbor (KNN), a suitable statistical machine learning algorithm, and/or a heuristic machine learning system for classifying or evaluating which testing parameters would be useful in a generated chaos scenario.

The methods described herein can be implemented with more than one machine learning method. The machine learning system can use a combination of machine learning algorithms. The machine learning algorithms may be of the same type or of different types. For example, a first machine learning algorithm may be trained for a first type of result, while a second machine learning algorithm may be trained for a second type of result. In certain examples, the first type of result may be an input into the second machine learning algorithm, while in other examples, the two results are combined to produce a third result. In certain examples, the first and second types of results are both inputs into a third machine learning algorithm that produces the third result.

### Linear Regression (LiR)

In one example embodiment, linear regression machine learning is implemented. LiR is typically used in machine learning to predict a result through the mathematical relationship between an independent and dependent variable. A simple linear regression model would have one independent variable (x) and one dependent variable (y). A representation of an example mathematical relationship of a simple linear regression model would be y=mx+b. In this example, the machine learning algorithm tries variations of the tuning variables m and b to optimize a line that includes all the given training data.

The tuning variables can be optimized, for example, with a cost function. A cost function takes advantage of the minimization problem to identify the optimal tuning variables. The minimization problem preposes the optimal tuning variable will minimize the error between the predicted outcome and the actual outcome. An example cost function may comprise summing all the square differences between the predicted and actual output values and dividing them by the total number of input values and results in the average square error.

To select new tuning variables to reduce the cost function, the machine learning module may use, for example, gradient descent methods. An example gradient descent method comprises evaluating the partial derivative of the cost function with respect to the tuning variables. The sign and magnitude of the partial derivatives indicate whether the choice of a new tuning variable value will reduce the cost function, thereby optimizing the linear regression algorithm. A new tuning variable value is selected depending on a set threshold. Depending on the machine learning module, a steep or gradual negative slope is selected. Both the cost function and gradient descent can be used with other algorithms and modules mentioned throughout. For the sake of brevity, both the cost function and gradient descent are well known in the art and are applicable to other machine learning algorithms and may not be mentioned with the same detail.

LiR models may have many levels of complexity comprising one or more independent variables. Furthermore, in an LiR function with more than one independent variable, each independent variable may have the same one or more tuning variables or each, separately, may have their own one or more tuning variables. The number of independent variables and tuning variables will be understood to one skilled in the art for the problem being solved. In example embodiments, chaos testing results are used as the independent variables to train a LiR machine learning module, which, after training, is used to estimate, for example, which testing parameters would be useful in a generated chaos scenario.

### Logistic Regression (LoR)

In one example embodiment, logistic regression machine learning is implemented. Logistic Regression, often considered a LiR type model, is typically used in machine learning to classify information, such as chaos testing results into categories such as which testing parameters would be useful in a generated chaos scenario. LoR takes advantage of probability to predict an outcome from input data. However, what makes LoR different from a LiR is that LoR uses a more complex logistic function, for example a sigmoid function. In addition, the cost function can be a sigmoid function limited to a result between 0 and 1. For example, the sigmoid function can be of the form ƒ(x)=1/(1+e^{-x}), where x represents some linear representation of input features and tuning variables. Similar to LiR, the tuning variable(s) of the cost function are optimized (typically by taking the log of some variation of the cost function) such that the result of the cost function, given variable representations of the input features, is a number between 0 and 1, preferably falling on either side of 0.5. As described in LiR, gradient descent may also be used in LoR cost function optimization and is an example of the process. In example embodiments, chaos testing results are used as the independent variables to train a LoR machine learning module, which, after training, is used to estimate, for example, which testing parameters would be useful in a generated chaos scenario.

### Bayesian Network

In one example embodiment, a Bayesian Network is implemented. BNs are used in machine learning to make predictions through Bayesian inference from probabilistic graphical models. In BNs, input features are mapped onto a directed acyclic graph forming the nodes of the graph. The edges connecting the nodes contain the conditional dependencies between nodes to form a predicative model. For each connected node the probability of the input features resulting in the connected node is learned and forms the predictive mechanism. The nodes may comprise the same, similar or different probability functions to determine movement from one node to another. The nodes of a Bayesian network are conditionally independent of its non-descendants given its parents thus satisfying a local Markov property. This property affords reduced computations in larger networks by simplifying the joint distribution.

There are multiple methods to evaluate the inference, or predictability, in a BN but only two are mentioned for demonstrative purposes. The first method involves computing the joint probability of a particular assignment of values for each variable. The joint probability can be considered the product of each conditional probability and, in some instances, comprises the logarithm of that product. The second method is Markov chain Monte Carlo (MCMC), which can be implemented when the sample size is large. MCMC is a well-known class of sample distribution algorithms and will not be discussed in detail herein.

The assumption of conditional independence of variables forms the basis for Naïve Bayes classifiers. This assumption implies there is no correlation between different input features. As a result, the number of computed probabilities is significantly reduced as well as the computation of the probability normalization. While independence between features is rarely true, this assumption exchanges reduced computations for less accurate predictions, however the predictions are reasonably accurate. In example embodiments, chaos testing results are mapped to the BN graph to train the BN machine learning module, which, after training, is used to select which testing parameters would be useful in a generated chaos scenario.

### Random Forest

In one example embodiment, random forest (“RF”) is implemented. RF consists of an ensemble of decision trees producing individual class predictions. The prevailing prediction from the ensemble of decision trees becomes the RF prediction. Decision trees are branching flowchart-like graphs comprising of the root, nodes, edges/branches, and leaves. The root is the first decision node from which feature information is assessed and from it extends the first set of edges/branches. The edges/branches contain the information of the outcome of a node and pass the information to the next node. The leaf nodes are the terminal nodes that output the prediction. Decision trees can be used for both classification as well as regression and is typically trained using supervised learning methods. Training of a decision tree is sensitive to the training data set. An individual decision tree may become over or under-fit to the training data and result in a poor predictive model. Random forest compensates by using multiple decision trees trained on different data sets. In example embodiments, chaos testing results are used to train the nodes of the decision trees of a RF machine learning module, which, after training, is used to select which testing parameters would be useful in a generated chaos scenario.

### Gradient Boosting

In an example embodiment, gradient boosting is implemented. Gradient boosting is a method of strengthening the evaluation capability of a decision tree node. In general, a tree is fit on a modified version of an original data set. For example, a decision tree is first trained with equal weights across its nodes. The decision tree is allowed to evaluate data to identify nodes that are less accurate. Another tree is added to the model and the weights of the corresponding underperforming nodes are then modified in the new tree to improve their accuracy. This process is performed iteratively until the accuracy of the model has reached a defined threshold or a defined limit of trees has been reached. Less accurate nodes are identified by the gradient of a loss function. Loss functions must be differentiable such as a linear or logarithmic functions. The modified node weights in the new tree are selected to minimize the gradient of the loss function. In an example embodiment, a decision tree is implemented to determine a chaos testing results and gradient boosting is applied to the tree to improve its ability to accurately determine which testing parameters would be useful in a generated chaos scenario.

### Neural Networks

In one example embodiment, Neural Networks are implemented. NNs are a family of statistical learning models influenced by biological neural networks of the brain. NNs can be trained on a relatively-large dataset (e.g., 50,000 or more) and used to estimate, approximate, or predict an output that depends on a large number of inputs/features. NNs can be envisioned as so-called “neuromorphic” systems of interconnected processor elements, or “neurons”, and exchange electronic signals, or “messages”. Similar to the so-called “plasticity” of synaptic neurotransmitter connections that carry messages between biological neurons, the connections in NNs that carry electronic “messages” between “neurons” are provided with numeric weights that correspond to the strength or weakness of a given connection. The weights can be tuned based on experience, making NNs adaptive to inputs and capable of learning. For example, an NN for chaos testing results is defined by a set of input neurons that can be given input data such as previous testing results. The input neuron weighs and transforms the input data and passes the result to other neurons, often referred to as “hidden” neurons. This is repeated until an output neuron is activated. The activated output neuron produces a result. In example embodiments, previous testing results are used to train the neurons in a NN machine learning module, which, after training, is used to select which testing parameters would be useful in a generated chaos scenario.

### Convolutional Autoencoder

In example embodiments, convolutional autoencoder (CAE) is implemented. A CAE is a type of neural network and comprises, in general, two main components. First, the convolutional operator that filters an input signal to extract features of the signal. Second, an autoencoder that learns a set of signals from an input and reconstructs the signal into an output. By combining these two components, the CAE learns the optimal filters that minimize reconstruction error resulting an improved output. CAEs are trained to only learn filters capable of feature extraction that can be used to reconstruct the input. Generally, convolutional autoencoders implement unsupervised learning. In example embodiments, the convolutional autoencoder is a variational convolutional autoencoder. In example embodiments, features from chaos testing results are used as an input signal into a CAE which reconstructs that signal into an output such as a which testing parameters would be useful in a generated chaos scenario.

### Deep Learning

In example embodiments, deep learning is implemented. Deep learning expands the neural network by including more layers of neurons. A deep learning module is characterized as having three “macro” layers: (1) an input layer which takes in the input features, and fetches embeddings for the input, (2) one or more intermediate (or hidden) layers which introduces nonlinear neural net transformations to the inputs, and (3) a response layer which transforms the final results of the intermediate layers to the prediction. In example embodiments, chaos testing results are used to train the neurons of a deep learning module, which, after training, is used to estimate which testing parameters would be useful in a generated chaos scenario.

### Convolutional Neural Network (CNN)

In an example embodiment, a convolutional neural network is implemented. CNNs is a class of NNs further attempting to replicate the biological neural networks, but of the animal visual cortex. CNNs process data with a grid pattern to learn spatial hierarchies of features. Wherein NNs are highly connected, sometimes fully connected, CNNs are connected such that neurons corresponding to neighboring data (e.g., pixels) are connected. This significantly reduces the number of weights and calculations each neuron must perform.

In general, input data, such chaos testing results, comprises of a multidimensional vector. A CNN, typically, comprises of three layers: convolution, pooling, and fully connected. The convolution and pooling layers extract features and the fully connected layer combines the extracted features into an output, such as which testing parameters would be useful in a generated chaos scenario.

In particular, the convolutional layer comprises of multiple mathematical operations such as of linear operations, a specialized type being a convolution. The convolutional layer calculates the scalar product between the weights and the region connected to the input volume of the neurons. These computations are performed on kernels, which are reduced dimensions of the input vector. The kernels span the entirety of the input. The rectified linear unit (i.e., ReLu) applies an elementwise activation function (e.g., sigmoid function) on the kernels.

CNNs can optimized with hyperparameters. In general, there three hyperparameters are used: depth, stride, and zero-padding. Depth controls the number of neurons within a layer. Reducing the depth may increase the speed of the CNN but may also reduce the accuracy of the CNN. Stride determines the overlap of the neurons. Zero-padding controls the border padding in the input.

The pooling layer down-samples along the spatial dimensionality of the given input (i.e., convolutional layer output), reducing the number of parameters within that activation. As an example, kernels are reduced to dimensionalities of 2×2 with a stride of 2, which scales the activation map down to 25%. The fully connected layer uses inter-layer-connected neurons (i.e., neurons are only connected to neurons in other layers) to score the activations for classification and/or regression. Extracted features may become hierarchically more complex as one layer feeds its output into the next layer. See O'Shea, K.; Nash, R. An Introduction to Convolutional Neural Networks. arXiv 2015 and Yamashita, R., et al Convolutional neural networks: an overview and application in radiology. Insights Imaging 9, 611-629 (2018).

### Recurrent Neural Network (RNN)

In an example embodiment, a recurrent neural network is implemented. RNNs are class of NNs further attempting to replicate the biological neural networks of the brain. RNNs comprise of delay differential equations on sequential data or time series data to replicate the processes and interactions of the human brain. RNNs have “memory” wherein the RNN can take information from prior inputs to influence the current output. RNNs can process variable length sequences of inputs by using their “memory” or internal state information. Where NNs may assume inputs are independent from the outputs, the outputs of RNNs may be dependent on prior elements with the input sequence. For example, input such as chaos testing results is received by a RNN, which determines which testing parameters would be useful in a generated chaos scenario. See Sherstinsky, Alex. “Fundamentals of recurrent neural network (RNN) and long short-term memory (LSTM) network.” Physica D: Nonlinear Phenomena 404 (2020): 132306.

### Long Short-Term Memory (LSTM)

In an example embodiment, a Long Short-term Memory is implemented. LSTM are a class of RNNs designed to overcome vanishing and exploding gradients. In RNNs, long term dependencies become more difficult to capture because the parameters or weights either do not change with training or fluctuate rapidly. This occurs when the RNN gradient exponentially decreases to zero, resulting in no change to the weights or parameters, or exponentially increases to infinity, resulting in large changes in the weights or parameters. This exponential effect is dependent on the number of layers and multiplicative gradient. LSTM overcomes the vanishing/exploding gradients by implementing “cells” within the hidden layers of the NN. The “cells” comprise three gates: an input gate, an output gate, and a forget gate. The input gate reduces error by controlling relevant inputs to update the current cell state. The output gate reduces error by controlling relevant memory content in the present hidden state. The forget gate reduces error by controlling whether prior cell states are put in “memory” or forgotten. The gates use activation functions to determine whether the data can pass through the gates. While one skilled in the art would recognize the use of any relevant activation function, example activation functions are sigmoid, tan h, and RELU. See Zhu, Xiaodan, et al. “Long short-term memory over recursive structures.” International Conference on Machine Learning. PMLR, 2015.

### Matrix Factorization

In example embodiments, Matrix Factorization is implemented. Matrix factorization machine learning exploits inherent relationships between two entities drawn out when multiplied together. Generally, the input features are mapped to a matrix F which is multiplied with a matrix R containing the relationship between the features and a predicted outcome. The resulting dot product provides the prediction. The matrix R is constructed by assigning random values throughout the matrix. In this example, two training matrices are assembled. The first matrix X contains training input features and the second matrix Z contains the known output of the training input features. First the dot product of R and X are computed and the square mean error, as one example method, of the result is estimated. The values in R are modulated and the process is repeated in a gradient descent style approach until the error is appropriately minimized. The trained matrix R is then used in the machine learning model. In example embodiments, chaos testing results are used to train the relationship matrix R in a matrix factorization machine learning module. After training, the relationship matrix R and input matrix F, which comprises vector representations of chaos testing results, results in the prediction matrix P comprising which testing parameters would be useful in a generated chaos scenario.

### Hidden Markov Model

In example embodiments, a hidden Markov model is implemented. A HMM takes advantage of the statistical Markov model to predict an outcome. A Markov model assumes a Markov process, wherein the probability of an outcome is solely dependent on the previous event. In the case of HMM, it is assumed an unknown or “hidden” state is dependent on some observable event. A HMM comprises a network of connected nodes. Traversing the network is dependent on three model parameters: start probability; state transition probabilities; and observation probability. The start probability is a variable that governs, from the input node, the most plausible consecutive state. From there each node i has a state transition probability to node j. Typically the state transition probabilities are stored in a matrix Mᵢⱼ wherein the sum of the rows, representing the probability of state i transitioning to state j, equals 1. The observation probability is a variable containing the probability of output o occurring. These too are typically stored in a matrix Nₒⱼ wherein the probability of output o is dependent on state j. To build the model parameters and train the HMM, the state and output probabilities are computed. This can be accomplished with, for example, an inductive algorithm. Next, the state sequences are ranked on probability, which can be accomplished, for example, with the Viterbi algorithm. Finally, the model parameters are modulated to maximize the probability of a certain sequence of observations. This is typically accomplished with an iterative process wherein the neighborhood of states is explored, the probabilities of the state sequences are measured, and model parameters updated to increase the probabilities of the state sequences. In example embodiments, chaos testing results are used to train the nodes/states of the HMM machine learning module, which, after training, is used to select which testing parameters would be useful in a generated chaos scenario.

### Support Vector Machine

In example embodiments, support vector machines are implemented. SVMs separate data into classes defined by n-dimensional hyperplanes (n-hyperplane) and are used in both regression and classification problems. Hyperplanes are decision boundaries developed during the training process of a SVM. The dimensionality of a hyperplane depends on the number of input features. For example, a SVM with two input features will have a linear (1-dimensional) hyperplane while a SVM with three input features will have a planer (2-dimensional) hyperplane. A hyperplane is optimized to have the largest margin or spatial distance from the nearest data point for each data type. In the case of simple linear regression and classification a linear equation is used to develop the hyperplane. However, when the features are more complex a kernel is used to describe the hyperplane. A kernel is a function that transforms the input features into higher dimensional space. Kernel functions can be linear, polynomial, a radial distribution function (or gaussian radial distribution function), or sigmoidal. In example embodiments, chaos testing results are used to train the linear equation or kernel function of the SVM machine learning module, which, after training, is used to select which testing parameters would be useful in a generated chaos scenario.

### K-Means Clustering

In one example embodiment, K-means clustering is implemented. KMC assumes data points have implicit shared characteristics and “clusters” data within a centroid or “mean” of the clustered data points. During training, KMC adds a number of k centroids and optimizes its position around clusters. This process is iterative, where each centroid, initially positioned at random, is re-positioned towards the average point of a cluster. This process concludes when the centroids have reached an optimal position within a cluster. Training of a KMC module is typically unsupervised. In example embodiments, chaos testing results are used to train the centroids of a KMC machine learning module, which, after training, is used to select which testing parameters would be useful in a generated chaos scenario.

### K-Nearest Neighbor

In one example embodiment, K-nearest neighbor is implemented. On a general level, KNN shares similar characteristics to KMC. For example, KNN assumes data points near each other share similar characteristics and computes the distance between data points to identify those similar characteristics but instead of k centroids, KNN uses k number of neighbors. The k in KNN represents how many neighbors will assign a data point to a class, for classification, or object property value, for regression. Selection of an appropriate number of k is integral to the accuracy of KNN. For example, a large k may reduce random error associated with variance in the data but increase error by ignoring small but significant differences in the data. Therefore, a careful choice of k is selected to balance overfitting and underfitting. Concluding whether some data point belongs to some class or property value k, the distance between neighbors is computed. Common methods to compute this distance are Euclidean, Manhattan or Hamming to name a few. In some embodiments, neighbors are given weights depending on the neighbor distance to scale the similarity between neighbors to reduce the error of edge neighbors of one class “out-voting” near neighbors of another class. In one example embodiment, k is 1 and a Markov model approach is utilized. In example embodiments, chaos testing results are used to train a KNN machine learning module, which, after training, is used to select which testing parameters would be useful in a generated chaos scenario.

To perform one or more of its functionalities, the machine learning module may communicate with one or more other systems. For example, an integration system may integrate the machine learning module with one or more email servers, web servers, one or more databases, or other servers, systems, or repositories. In addition, one or more functionalities may require communication between a user and the machine learning module.

Any one or more of the module described herein may be implemented using hardware (e.g., one or more processors of a computer/machine) or a combination of hardware and software. For example, any module described herein may configure a hardware processor (e.g., among one or more hardware processors of a machine) to perform the operations described herein for that module. In some example embodiments, any one or more of the modules described herein may comprise one or more hardware processors and may be configured to perform the operations described herein. In certain example embodiments, one or more hardware processors are configured to include any one or more of the modules described herein.

Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. The multiple machines, databases, or devices are communicatively coupled to enable communications between the multiple machines, databases, or devices. The modules themselves are communicatively coupled (e.g., via appropriate interfaces) to each other and to various data sources, to allow information to be passed between the applications so as to allow the applications to share and access common data.

### Multimodal Translation

In an example embodiment, the machine learning module comprises multimodal translation (MT), also known as multimodal machine translation or multimodal neural machine translation. MT comprises of a machine learning module capable of receiving multiple (e.g. two or more) modalities. Typically, the multiple modalities comprise of information connected to each other.

In example embodiments, the MT may comprise of a machine learning method further described herein. In an example embodiment, the MT comprises a neural network, deep neural network, convolutional neural network, convolutional autoencoder, recurrent neural network, or an LSTM. For example, one or more microscopy imaging data comprising multiple modalities from a subject is embedded as further described herein. The embedded data is then received by the machine learning module. The machine learning module processes the embedded data (e.g. encoding and decoding) through the multiple layers of architecture then determines the corresponding the modalities comprising the input. The machine learning methods further described herein may be engineered for MT wherein the inputs described herein comprise of multiple modalities. See e.g. Sulubacak, U., Caglayan, O., Grönroos, S A. et al. Multimodal machine translation through visuals and speech. Machine Translation 34, 97-147 (2020) and Huang, Xun, et al. “Multimodal unsupervised image-to-image translation.” Proceedings of the European conference on computer vision (ECCV). 2018.

The ladder diagrams, scenarios, flowcharts and block diagrams in the figures and discussed herein illustrate architecture, functionality, and operation of example embodiments and various aspects of systems, methods, and computer program products of the present invention. Each block in the flowchart or block diagrams can represent the processing of information and/or transmission of information corresponding to circuitry that can be configured to execute the logical functions of the present techniques. Each block in the flowchart or block diagrams can represent a module, segment, or portion of one or more executable instructions for implementing the specified operation or step. In example embodiments, the functions/acts in a block can occur out of the order shown in the figures and nothing requires that the operations be performed in the order illustrated. For example, two blocks shown in succession can executed concurrently or essentially concurrently. In another example, blocks can be executed in the reverse order. Furthermore, variations, modifications, substitutions, additions, or reduction in blocks and/or functions may be used with any of the ladder diagrams, scenarios, flow charts and block diagrams discussed herein, all of which are explicitly contemplated herein.

The ladder diagrams, scenarios, flow charts and block diagrams may be combined with one another, in part or in whole. Coordination will depend upon the required functionality. Each block of the block diagrams and/or flowchart illustration as well as combinations of blocks in the block diagrams and/or flowchart illustrations can be implemented by special purpose hardware-based systems that perform the aforementioned functions/acts or carry out combinations of special purpose hardware and computer instructions. Moreover, a block may represent one or more information transmissions and may correspond to information transmissions among software and/or hardware modules in the same physical device and/or hardware modules in different physical devices.

The present techniques can be implemented as a system, a method, a computer program product, digital electronic circuitry, and/or in computer hardware, firmware, software, or in combinations of them. The system may comprise distinct software modules embodied on a computer readable storage medium; the modules can include, for example, any or all of the appropriate elements depicted in the block diagrams and/or described herein; by way of example and not limitation, any one, some, or all of the modules/blocks and or sub-modules/sub-blocks described. The method steps can then be carried out using the distinct software modules and/or sub-modules of the system, as described above, executing on one or more hardware processors.

### Example Systems

FIG. 7 depicts a computing machine 2000 and a module 2050 in accordance with certain examples. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components, for example, a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (DSP), an application specific integrated circuit (ASIC), a graphics processing unit (GPU), a field programmable gate array (FPGA), a programmable logic device (PLD), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain examples, the processor 2010 along with other components of the computing machine 2000 may be a virtualized computing machine executing within one or more other computing machines.

The system memory 2030 may include non-volatile memories, for example, read-only memory (ROM), programmable read-only memory (PROM), erasable programmable read-only memory (EPROM), flash memory, or any other device capable of storing program instructions or data with or without applied power. The system memory 2030 may also include volatile memories, for example, random access memory (RAM), static random access memory (SRAM), dynamic random access memory (DRAM), and synchronous dynamic random access memory (SDRAM). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device, for example, the storage media 2040.

The storage media 2040 may include a hard disk, a floppy disk, a compact disc read only memory (CD-ROM), a digital versatile disc (DVD), a Blu-ray disc, a magnetic tape, a flash memory, other non-volatile memory device, a solid state drive (SSD), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules, for example, module 2050, data, or any other information. The storage media 2040 may be part of, or connected to, the computing machine 2000. The storage media 2040 may also be part of one or more other computing machines that are in communication with the computing machine 2000, for example, servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits, for example, microcode or configuration information for an FPGA or other PLD.

The input/output (I/O) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, for example, small computer system interface (SCSI), serial-attached SCSI (SAS), fiber channel, peripheral component interconnect (PCI), PCI express (PCIe), serial bus, parallel bus, advanced technology attached (ATA), serial ATA (SATA), universal serial bus (USB), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or analog communication media, for example, fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to certain examples, any of the processor 2010, the other elements of the computing machine 2000, or the various peripherals discussed herein may be integrated into a single device, for example, a system on chip (SOC), system on package (SOP), or ASIC device.

Examples may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing examples in computer programming, and the examples should not be construed as limited to any one set of computer program instructions. Further, a skilled programmer would be able to write such a computer program to implement an example of the disclosed examples based on the appended flow charts and associated description in the application text. Therefore, disclosure of a particular set of program code instructions is not considered necessary for an adequate understanding of how to make and use examples. Further, those skilled in the art will appreciate that one or more aspects of examples described herein may be performed by hardware, software, or a combination thereof, as may be embodied in one or more computing systems. Additionally, any reference to an act being performed by a computer should not be construed as being performed by a single computer as more than one computer may perform the act.

The examples described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the examples presented previously are illustrative, and, in alternative examples, certain acts can be performed in a different order, in parallel with one another, omitted entirely, and/or combined between different example examples, and/or certain additional acts can be performed, without departing from the scope and spirit of various examples. Accordingly, such alternative examples are included in the scope of the following claims, which are to be accorded the broadest interpretation so as to encompass such alternate examples.

Although specific examples have been described above in detail, the description is merely for purposes of illustration. It should be appreciated, therefore, that many aspects described above are not intended as required or essential elements unless explicitly stated otherwise.

Modifications of, and equivalent components or acts corresponding to, the disclosed aspects of the examples, in addition to those described above, can be made by a person of ordinary skill in the art, having the benefit of the present disclosure, without departing from the spirit and scope of examples defined in the following claims, the scope of which is to be accorded the broadest interpretation so as to encompass such modifications and equivalent structures.

1. A system to use machine learning systems to create chaos testing scenarios on cloud-based applications, comprising:
a storage device in a cloud-based computing network; and
one or more hardware processors operating on a server in the cloud-based computing network communicatively coupled to the storage device, wherein the one or more hardware processors use machine learning processes to execute instructions that are stored in the storage device to cause the system to:
create an application model of an application based on input data received from a network of applications, the application comprising a plurality of microservices that make up the application, wherein the application model represents a plurality of dependencies between or among the plurality of microservices;
identify, based on the application model using a machine learning model, points of failure of the application in the plurality of microservices;
generate, based on the application model using the machine learning model, one or more chaos testing simulation scenarios that target the points of failure, wherein the one or more chaos testing simulation scenarios comprise a combination of chaos tests to push the application into a constant state of perturbation;
perform chaos testing based on the one or more chaos testing simulation scenarios to push the application into the constant state of perturbation; and
generate recommendations to revise code of the application based on the chaos testing.

2. (canceled)

3. The system of claim 1, further comprising application code instructions to cause the system to recognize patterns of code behavior that may lead to instability or failures.

4. The system of claim 3, wherein a chaos simulation scenario comprises one or more instructions to inject faults, introduce latency, or simulate resource constraints in areas of the code where recognized patterns are detected.

5. The system of claim 1, further comprising application code instructions to cause the system to prioritize the one or more chaos testing simulation scenarios based on one or more of code complexity, criticality of components, and historical failure data.

6. The system of claim 5, wherein the application code instructions cause the one or more hardware processors to:
monitor a status of the application during performance of the chaos testing;
compare the status to an operational status that occurs when chaos conditions are not present and an expected operational status of the application when under the chaos conditions; and
revise, based on comparing the status to the operational status, the one or more chaos testing simulation scenarios.

7. The system of claim 1, wherein a particular machine learning process of the machine learning processes is a large language model.

8. The system of claim 7, wherein the large language model further generates the one or more chaos testing simulation scenarios based on textual descriptions of objectives provided by a user.

9. The system of claim 7, wherein the large language model analyzes documentation and code comments of the application to extract data related to architecture and the plurality of dependencies of the application.

10. The system of claim 7, wherein the large language model further reviews one or more changes to the code and assess their impact on chaos engineering practices.

11. The system of claim 7, wherein the large language model further develops natural language interfaces to interact with users.

12. The system of claim 7, wherein the large language model further generates documentation for the one or more chaos testing simulation scenarios.

13. The system of claim 7, wherein the large language model further generates natural language reports summarizing results of the one or more chaos testing simulation scenarios.

14. A method to use machine learning systems to create chaos testing scenarios on cloud-based applications, comprising:
creating an application model of an application based on input data received from a network of applications, the application comprising a plurality of microservices that make up the application, wherein the application model represents a plurality of dependencies between or among the plurality of microservices;
identifying, based on the application model using a machine learning model, points of failure of the application in the plurality of microservices;
generating, based on the application model using the machine learning model, one or more chaos testing simulation scenarios that target the points of failure, wherein the one or more chaos testing simulation scenarios comprise a combination of chaos tests to push the application into a constant state of perturbation;
performing chaos testing based on the one or more chaos testing simulation scenarios to push the application into the constant state of perturbation; and
generating recommendations to revise code of the application based on the chaos testing.

15. The method of claim 14, further comprising mapping the plurality of dependencies of the application.

16. The method of claim 14, wherein a chaos scenario comprises instructions to inject faults, introduce latency, or simulate resource constraints in areas of the code where recognized patterns are detected.

17. The method of claim 14, wherein the machine learning systems utilize a large language model.

18. A computer program product, comprising:
a non-transitory computer-readable medium having computer-readable program instructions embodied thereon, the computer-readable program instructions causing one or more processors to:
create an application model of an application based on input data received from a network of applications, the application comprising a plurality of microservices that make up the application, wherein the application model represents a plurality of dependencies between or among the plurality of microservices;
identify, based on the application model using a machine learning model, points of failure of the application in the plurality of microservices;
generate, based on the application model using the machine learning model, one or more chaos testing simulation scenarios that target the points of failure, wherein the one or more chaos testing simulation scenarios comprise a combination of chaos tests to push the application into a constant state of perturbation;
perform chaos testing based on the one or more chaos testing simulation scenarios to push the application into the constant state of perturbation; and
generate recommendations to revise code of the application based on the chaos testing.

19. The computer program product of claim 18, wherein the computer-readable program instructions cause the one or more processors to prioritize the one or more of chaos testing simulation scenarios based on one or more of code complexity, criticality of components, and historical failure data.

20. The computer program product of claim 18, wherein the computer-readable program instructions cause the one or more processors to:
monitor a status of the application during performance of the chaos testing;
compare the status to an operational status that occurs when chaos conditions are not present and an expected operational status of the application when under the chaos conditions; and
revise, based on comparing the status to the operational status, the one or more chaos testing simulation scenarios.

21. The system of claim 1, wherein the instructions for performing the chaos testing based on the one or more chaos testing simulation scenarios cause the one or more hardware processors to perform operations comprising:
receiving application data associated with the application, wherein the application data includes a first set of performance metrics during standard operating conditions and a second set of performance metrics during upset conditions, and wherein the upset conditions comprise network delays or power interruptions;
comparing the application data with model data of the application model; and
predicting, based on comparing the application data with the model data of the application model, an application response to the chaos testing.
